(19) United States
(12) Patent Application Publication
(10) Pub. No.: US 2021/0405865 A1
(43) Pub. Date: Dec. 30, 2021

(54) DYNAMIC POSITIONING OF CONTENT VIEWS BASED ON A CAMERA POSITION RELATIVE TO A DISPLAY SCREEN

(71) Applicant: MICROSOFT TECHNOLOGY LICENSING, LLC, Redmond, WA (US)

(72) Inventor: Jason Thomas FAULKNER, Seattle, WA (US)

(21) Appl. No.: 16/914,136

(22) Filed: Jun. 26, 2020

(51) Int. Cl. G06F 3/0488; G06F 3/01; G06F 3/0481; G06F 1/16

(52) U.S. Cl. CPC G06F 3/04886; G06F 3/013; G06F 2200/1637; G06F 1/1694; G06F 2200/1614; G06F 3/04812

(57) ABSTRACT

The disclosed techniques optimize the use of computing resources by dynamically positioning content views based on a location of a camera relative to a display screen. The dynamically positioned content views are positioned in proximity to a camera to guide an eye gaze direction of a presenter toward a camera generating video data for transmission to remote devices participating in a communication session. The described systems improve a presenter's ability to direct eye contact toward a camera to allow for effective communication of gestures with an audience receiving a stream from the camera. A position, size and/or shape of a content view can be based on a camera position relative to a display screen to improve the accessibility and efficiencies of computing resources.

### BACKGROUND

There are a number of communication systems that allow users to collaborate. For example, some systems allow people to collaborate by the use of live video streams, live audio streams, and other forms of text-based or image-based mediums. Participants of a communication session can share a video stream showing a single person or a group of people with a display of shared content. Such systems can provide participants of a communication session with an experience that simulates an in-person meeting.

Although there are a number of systems that allow users to collaborate and share content, such systems still have a number of shortcomings. For instance, some user interface arrangements and hardware configurations may not optimally promote user engagement during live video conferences. This may occur when a user is transmitting of a video stream of themselves while they are looking at content displayed on their screen. When the content is not displayed near a presenter's camera, it is more difficult for the presenter to give the audience the appearance that they are making direct eye contact with the camera. In some cases, the user may appear to be looking away from his or her audience. This can be undesirable particularly in situations where a presenter is trying to use facial gestures to engage an audience or emphasize aspects of their presentation. Missed gestures or missed cues during a presentation can lead to a need for prolonged meetings or a need for the use of additional communication mediums, which require additional consumption of computing resources.

This issue can be exacerbated in a situation where a device has multiple display screens. In such situations, if a presenter is interacting with displayed content on one screen while a camera is attached to another screen, the presenter may not be in a position to obtain an optimal camera angle for the communicating a range of gestures. Not only does this make it difficult for the presenter to be seen, this shortcoming may even make it difficult for an audience to understand what the presenter is trying to convey.

These issues can also impact the accessibility of some systems. For instance, audience members who rely on or supplement their communication session experience with lipreading techniques may not be able to see a presenter if the presenter is not aligned appropriately with a camera. Systems that do not enable a presenter to be properly aligned with a camera can cause a host of issues and greatly impact the effectiveness and accessibility of a communication system.

Computing devices that do not promote user engagement can lead to production loss and inefficiencies with respect to a number computing resources. For instance, participants of a communication session, such as an online meeting, may need to refer to recordings or other resources when live content is missed or overlooked. Content may need to be re-sent when viewers miss salient points or cues during a live meeting. Viewers may also have to re-watch content when they miss salient points or cues during a viewing of a recorded presentation. Such activities can lead to inefficient use a network, processor, memory, or other computing resources. Also, when a participant's level of engagement is negatively impacted during a meeting, such a loss of production may cause a need for prolonged meetings or follow-up meetings, which in turn take additional computing resources. Such inefficiencies can be exacerbated when a system is used to provide a collaborative environment for a large number of participants.

In addition to a loss in user engagement, a number of resource inefficiencies can result when communication systems do not effectively display a live video of a person. Participants can miss important social cues, e.g., when a person raises their hand, begins to speak, looks in a certain direction, etc. Such shortcomings sometimes require users to manually interact with a number of different systems. For example, users who miss important cues or gestures may start to utilize additional computing resources to communicate using text messages, emails, or other forms of communication. Such manual steps can be disruptive to a person's workflow and highly inefficient when it comes to helping a person establish a collaboration protocol with a group of people. Such drawbacks of existing systems can lead to loss of productivity as well as inefficient use of computing resources.

### SUMMARY

The disclosed techniques optimize the use of computing resources by dynamically positioning content views based on a camera's position relative to a display screen. The dynamically positioned content views are positioned in proximity to a camera to enable a presenter to look at displayed content while improving the presenter's ability to make eye contact with the camera that shares a video of the presenter to an audience. In some configurations, a system can be configured to determine a position, shape or size of a content rendering to guide an eye gaze direction of a presenter toward a camera generating video data for transmission to remote devices participating in a communication session. For example, for an iPad, when held in portrait mode, the camera is in the top-center area above the screen. Similarly, for a Galaxy S10+, when held in portrait mode, the camera is in the top-right area above the screen. In response to detecting configuration data indicating the position of the camera relative to the screen and an orientation of the device, a user interface displaying content to the presenter can be moved to a select location, e.g., the top-center area of the screen for an iPad or the top-right area of the screen for the Galaxy S10+. By dynamically positioning a content view, e.g., a user interface displaying a content rendering, in proximity to a camera, a user can portray a higher level of engagement to an audience viewing the video stream generated by the camera. In some configurations, a system can also control a size and/or shape of a content view based on data indicating one or more characteristics of a camera.

In some configurations, a system can monitor an orientation of a device and determine if the device is held in a landscape orientation, portrait orientation, or even an angled orientation. The system can then position displayed content at a position within a display screen that is in proximity to a camera. When the device is rotated from a first orientation to a second orientation, the device can detect a change in the camera's location relative to the screen and position displayed content in proximity to the camera. Instead of displaying the content in one predetermined position, such as the top of a screen in all scenarios, the techniques disclosed herein control the position of displayed content to “follow” the camera.

In some configurations, a system can include multiple display screens and multiple cameras to enable a “follow me” feature. In such configurations, a device can monitor a position of a user to determine select a display screen from a number of display screens that provides the most optimal view of displayed content from the user's location. The system also selects a camera from a number of cameras that provides an optimal view of the user from the user's location. A user interface displaying the content is moved to the selected monitor and the selected camera is activated so an audience receiving a video stream from the camera can be engaged with the user while the user is viewing the content. Thus, instead of requiring a user to move a display of content, or requiring a user to manually activate specific cameras, the system can track a person's movement and automatically display rendered content on a display screen near a user and also activate a camera near the user to enable the audience to “follow” the user's movement. By tracking a person's movement, the device can maximize the person's engagement with an audience and allow an audience to see the user's gestures.

In some configurations, a system can include multiple display screens and multiple cameras to enable a “lead me” feature. In such configurations, the system can keep a historical record of various positions of presenters that provide optimal stream characteristics such as camera angles, lighting, and audio signals. When a presenter starts to stream a presentation from a camera, the system can provide suggestions of positions for the presenter to optimize, light, camera angle and/or sound quality of a presentation. In some configurations, the suggestions can be in the form of a user interface that moves content to a different display screen to lead a user to a new position to optimize characteristics of a stream generated by a camera and/or microphone. The system can display content at a specific location within a selected display screen so an audience receiving a video stream from the camera can be engaged while the presenter is viewing the content.

The techniques disclosed herein provide a number of benefits that improve existing computers. For instance, computing resources such as processor cycles, memory, network bandwidth, and power, are used more efficiently as a system can dynamically control the size, position, or shape of content renderings based on a camera position relative to a display screen. The dynamic positioning of content based on a camera position can increase user engagement and thus reduce the need for additional communication that may be required when audience members miss cues, facial expressions, or other gestures performed by a presenter. In addition, the system that also enables a presenter to provide more direct eye contact with a camera which increases an audience's overall awareness and engagement. Such features can reduce the need for audience members to review recording of a presentation or engage in conversations with other audience members using external systems, e.g., text messages or instant messages, which all require additional computing resources. In addition, improved engagement and efficient interaction methods can lead to the reduction of inadvertent inputs, redundant inputs, and other types of user interactions that unnecessarily consume computing resources. Other technical benefits not specifically mentioned herein can also be realized through implementations of the disclosed subject matter.

Those skilled in the art will also appreciate that aspects of the subject matter described herein can be practiced on or in conjunction with other computer system configurations beyond those specifically described herein, including multiprocessor systems, microprocessor-based or programmable consumer electronics, augmented reality or virtual reality devices, video game devices, handheld computers, smartphones, smart televisions, self-driving vehicles, smart watches, e-readers, tablet computing devices, special-purpose hardware devices, networked appliances, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a diagram of several computer configurations each having a user interface positioned in proximity to a camera at a particular position relative to a display screen.

FIG. 2A shows an example user interface that is rotated and moved to different positions relative to a camera when a computing device is rotated in a first direction.

FIG. 2B shows an example user interface that is rotated and moved to different positions relative to a camera when a computing device is rotated in a second direction.

FIG. 2C shows an example user interface that is moved and rotated to different positions relative to a camera when a computing device is rotated to an angled orientation.

FIG. 3A shows an example user interface having an arrangement of renderings that is rearranged when a computing device is rotated in a first direction to keep a selected rendering in proximity to a camera.

FIG. 3B shows an example user interface having an arrangement of renderings that is rearranged when a computing device is rotated in a second direction to keep a selected rendering in proximity to a camera.

FIG. 4A shows a multi-screen system having a content rendering that is positioned on a select screen to place the content in proximity with a camera.

FIG. 4B shows a multi-screen system having a content rendering that is positioned on a first display screen when a camera is not transmitting a video stream, wherein the first display screen is further from a camera than a second display screen.

FIG. 4C illustrates a multiscreen scenario where the user interface crosses multiple display screens.

FIG. 5A shows a first step of a process where a system displays a user interface on a selected display device based on a position of a user and a position of a camera.

FIG. 5B shows a second step of a process where a system detects a location of a user for the purposes of placing a content rendering on a select screen of a multi-screen system to enable the user to interact with a camera while viewing the rendered content.

FIG. 5C shows a third step of a process where a system places a content rendering on a select screen of a multi-screen system to enable the user to interact with a camera while viewing the rendered content.

FIG. 5D shows a fourth step of a process where a system communicates a recommendation of a location for the user to optimize a camera angle, lighting or sound quality of a signal generated by a camera and other sensors.

FIG. 5E shows a fifth step of a process where the user is following the direction of the system to optimize a camera angle, lighting or sound quality of a signal generated by a camera and other sensors.

FIG. 6A shows a first step of a process where a system displays a user interface on a selected display device based on a position of a user and a position of a camera.

FIG. 6B shows a second step of a process where a system communicates a recommendation of a location for the user to optimize a camera angle, lighting or sound quality of a signal generated by a camera and other sensors.

FIG. 6C shows a third step of a process where the user is following the direction of the system to optimize a camera angle, lighting or sound quality of a signal generated by a camera and other sensors.

FIG. 7 is a flow diagram showing aspects of a routine for enabling the techniques disclosed herein.

FIG. 8 is a computer architecture diagram illustrating an illustrative computer hardware and software architecture for a computing system capable of implementing aspects of the techniques and technologies presented herein.

FIG. 9 is a diagram illustrating a distributed computing environment capable of implementing aspects of the techniques and technologies presented herein.

FIG. 10 is a computer architecture diagram illustrating a computing device architecture for a computing device capable of implementing aspects of the techniques and technologies presented herein.

### DETAILED DESCRIPTION

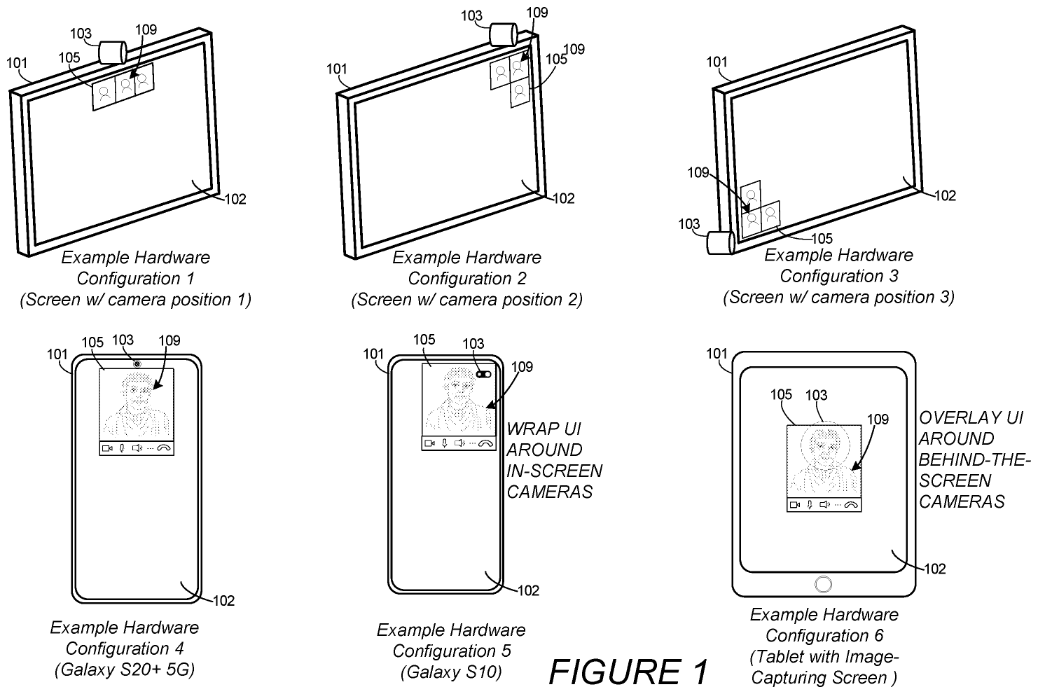

FIG. 1 is a diagram of several computer configurations each showing how content views can be dynamically positioned in proximity to a camera having a particular position relative to a display screen. As shown in these examples, the disclosed techniques optimize the use of computing resources by dynamically positioning content views based on a camera's position relative to a display screen. The dynamically positioned content views enable a user to look at displayed content while improving the user's ability to make eye contact with the camera. In some configurations, a system can be configured to guide an eye gaze direction of a user toward a camera generating video data for transmission to remote devices participating in a communication session. For illustrative purposes, a content view can include a user interface displaying rendered content. A content view can also include rendered content without user interface borders.

The first three examples of FIG. 1 show configurations where a computer 101 is in communication with a camera 103 that positioned in proximity to a display screen 102. In the first configuration, the camera 103 is positioned above the center of the display screen 102. Based on configuration data indicating this position of the camera 103, the computer 101 can position a user interface 105 with one or more renderings 109 near a top center portion of the display screen 102. In the second configuration, the camera 103 is positioned above the top right corner of the display screen 102. Based on configuration data indicating this position of the camera 103, the computer 101 can position a user interface 105 with one or more renderings of content 109 near the top right corner of the display screen 102. In the third configuration, the camera 103 is positioned to the left-bottom corner of the display screen 102. Based on configuration data indicating this position of the camera 103, the computer 101 can position a user interface 105 with one or more renderings 109 near the bottom-left corner of the display screen 102. Also shown, the shape of each user interface 105 can be changed to accommodate the shape of the display screen 102.

The last three examples of FIG. 1 show configurations where a computer 101 has a camera 103 mounted within a display screen 102. In the fourth configuration, the computer 101 is a Samsung Galaxy S20+5G. In this example, the camera is mounted within the screen 102 surface area and positioned near a top border of the screen 102 near the centerline of the screen 102. In such a configuration, the computer 101 can analyze configuration data indicating the position of the camera 103. In response to the configuration data, the computer can position a user interface (UI) 105 with one or more renderings of content 109 near the top center portion of the screen 102. In this embodiment, the centerline of the rendering 109 is aligned with the camera 103. In addition, the rendering 109 is positioned below the camera 103 to prevent the user interface 105 from wrapping around the camera.

In the fifth configuration, the computer 101 is a Samsung Galaxy S10. In this example, the camera 103 is mounted within the screen 102 and positioned near a top right corner of the screen 102. In such a configuration, the computer 101 can analyze configuration data indicating this position of the camera 103. In response to the configuration data, the computer can position a UI 105 with one or more renderings of content 109 near the top right corner of the screen 102. In some embodiments, the UI 105 is wrapped around the camera 103. A UI 105 can be wrapped around a camera when the computer determines that there is a threshold distance between the camera and at least one border of the display screen. In such embodiments, when the computer determines that the distance between the camera and at least one border of the display screen does not meet a threshold, the UI 105 can be positioned next to the camera without wrapping around the camera 103, as shown in the fourth example. Such embodiments enable the computer to position a salient portion of the rendering, such as a depicted person's eyes, close to the camera 103. This can help the user of the computer 101 portray a more realistic level of eye contact with the recipient of a video stream generated by the camera 103.

In the sixth configuration, the computer 101 is a tablet having a camera 103 that is positioned behind the display screen 102. In this example, the camera 103 is mounted behind the screen 102 and configured to capture an image from light directed toward the screen from a user of the computer 101. In such a model, the computer 101 can analyze configuration data indicating this position of the camera 103. In response to the configuration data, the computer can position a UI 105 with one or more renderings of content 109 near the center of the screen 102. In some embodiments, the UI 105 is wrapped around the camera 103, e.g., a section of the screen that can capture images. The UI can be positioned such that a center point of a rendered object, such as a person shown in the UI, can be aligned with a center point of the image capturing area of the camera 103. This configuration of the user interface enables the computer to position a salient portion of the rendering, such as a depicted person's eyes, close to the camera 103. This can help the user of the computer 101 portray a more realistic level of eye contact with the recipient of a video stream generated by the camera 103.

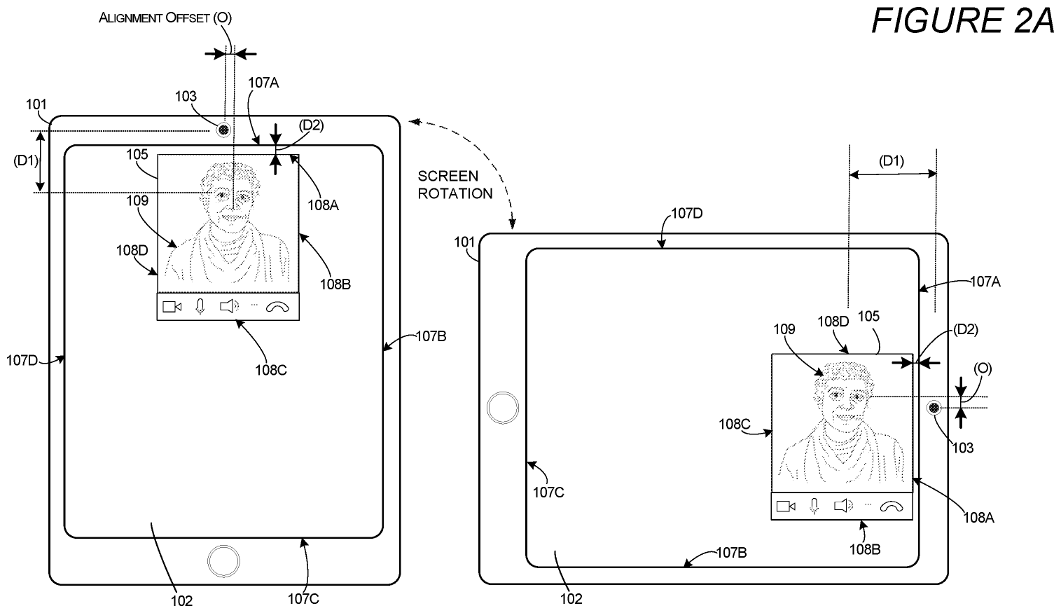

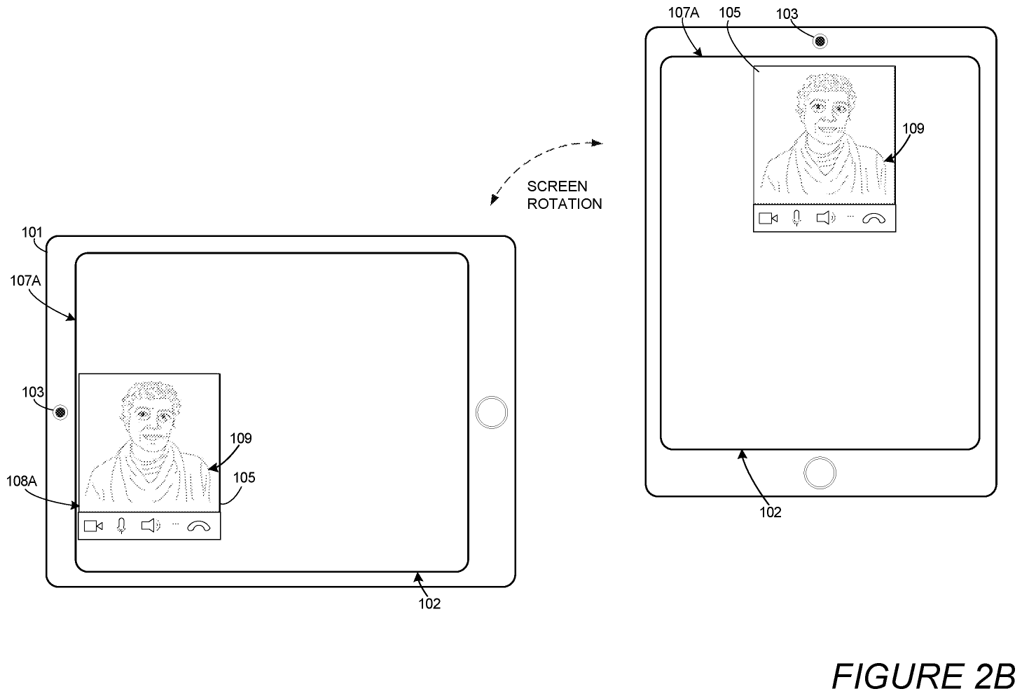

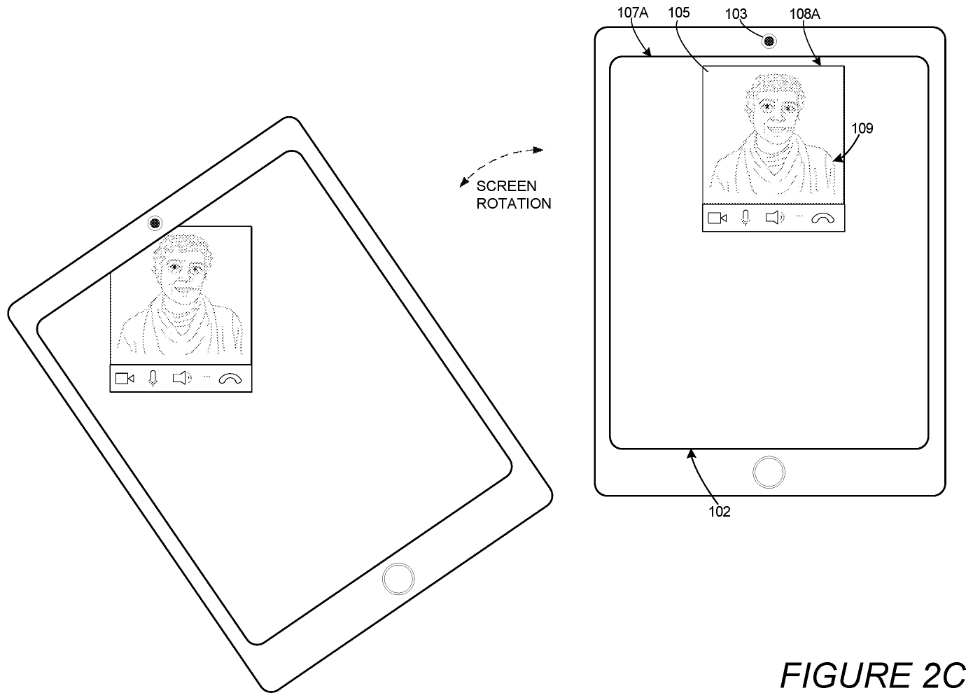

Referring now to FIG. 2A, examples of various techniques for determining a location for a content rendering 109 are shown and described below. As described below, in some configurations, the position of a content rendering 109 can be based on a predetermined point within the content, such as a person's eyes, the center of a person's face, a center of mass of an object, a center point of an image, etc. The predetermined point can be positioned relative to a position of a camera. In addition, in some configurations, the position of a content rendering 109 can be based on a position of a user interface border 108 relative to a display screen border 107. The embodiments described below illustrate several examples of how rendered content can be positioned relative to a camera 103 to allow a user to direct their eye gaze towards the camera 103 to promote engagement with an audience.

In some embodiments, the computing device can minimize or at least reduce the distance (D1) between a depicted object and the camera to a threshold distance. By minimizing or at least reducing the distance between the object depicted in the user interface and the camera, a user can look at the depicted object while minimizing a gaze angle between the object and the camera. For illustrative purposes, a gaze angle can be an angle between a first gaze line and a second gaze line, where the first gaze line is the line between the user's eyes and a depicted object, and the second gaze line is the line between the user's eyes and a camera. The distance (D1) can be measured based on any predetermined point within a content rendering 109 such as a person's eyes, the center of a person's face, a center of mass of an object, etc. When the content comprises a rendering of data, the predetermined point can include items like an inflection point within the chart, salient text, etc. The threshold distance can be any value from zero to any predetermined distance. The computing device can also determine an offset (O) of the alignment between a predetermined point within a content rendering 109 and the camera. The predetermined point can be any point within a rendering such as a center of mass, a point associated with the eyes of a depicted person, a point in a chart, a region with a highlighted color, etc. The offset (0) can be any value from a negative value, e.g., which moves the object to the left of the camera, to zero, to a positive value, e.g., which moves the object to the right of the camera. In some configurations the offset can be based on a number of depicted objects, such as a number of people in a rendering, a size of a depicted object, or any other characteristic of a rendering.

In some embodiments, a position of a rendering 109 can also be based on a distance (D2) between a border 108 of the user interface (UI) 105 and a select portion of a border 107A of a display screen 102. The select portion of the border 107A of the display screen 102, which is also referred to herein as a “select display screen border,” is a portion of the display screen border that is physically closer to a camera 103 than any other portion 107B-107D of the display screen 102. The select portion of the border 107A can be a side that is closest to a camera if the display screen is a square or rectangle, a portion of the border 107A can also include a predetermined section of an arc that is closest to a camera if the display screen is a circle or ellipse, or the portion of the border 107A can be any other predetermined section of a border 107 of the display screen 102 that is closest to a camera 103.

In some embodiments, a rendering is in proximity to a camera when a user interface 105 displaying the rendering is in proximity to a select portion of the display screen border 107A. In some embodiments, a rendering is in proximity to a camera, or the user interface 105 is in proximity to the select portion of the display screen border 107A, when at least one UI border 108 is adjacent to the select portion 108A of the UI border 108. In some embodiments, a rendering is in proximity to a camera, or the user interface 105 is in proximity to at least one select portion of the border 107A of the display screen 102, when at least one border 108A of the user interface 105 displaying the rendering is within a predetermined distance (D2) to the select portion of the border 108A. A computing device can also reduce the predetermined distance (D2) to a minimum threshold. The minimum threshold can be a negative value, e.g., with some portions of the UI positioned outside the border of the display screen, or zero, or a positive value, as shown in FIG. 2A. The minimum threshold can also be determined based on a number of factors. For instance, the minimum threshold can be based on a brightness level, a contrast between a color within the user interface and a color depicted in the display screen outside of the user interface. In one illustrative example, the minimum threshold can be reduced as the brightness level is increased or as the contrast is increased or decreased. The minimum threshold can be based on a size of the UI relative to the size of the screen. A larger UI can cause the device to reduce or increase the minimum threshold. A number of depicted objects can also cause the device to increase or decrease the minimum threshold.

In some embodiments, a rendering is in proximity to a camera, or the user interface 105 is in proximity to at least one select portion of the border 107A of the display screen 102, when a border of the user interface 105 depicting the rendering is within a predetermined distance (D2) to the select portion of the UI border 108A without displaying any graphical elements, including any other UI, between the user interface 105 and the select border 107A. In such embodiments, the computing device can move a depicted object toward a camera and also remove any other graphical elements that were originally between the depicted object of the camera.

The computing device can minimize or at least reduce a distance between a depicted object and the camera by moving the user interface toward the camera. The movement and/or positioning of the user interface can be controlled by the boundaries of the display screen. For instance, as shown in the fifth configuration of FIG. 1, a computing device can be configured to align a depicted object with a camera, but the alignment may be limited by a system policy that limits the movement of the user interface to ensure that the borders of the user interface stay within a display screen.

In some embodiments, the movement of the user interface can be controlled by the position of the camera. For instance, as shown in the fourth configuration of FIG. 1, a computing device can be configured to align a depicted object with a camera and/or move the depicted object toward the camera. The distance between the depicted object and the camera and/or the alignment between the depicted object and the camera may be limited by the position of the user interface and the position of the camera. In this example, the object is moved toward the camera but the distance between the depicted object is limited such that the camera is positioned outside the border of the UI 105.

The computing device can also minimize or at least reduce a distance between the depicted object and the camera by cropping the image of the object to move the depicted object closer to the border of the user interface and thus closer to the camera. For instance, in the example shown on the left side of FIG. 2A, the image of the depicted person can be cropped such that the white space between the person and the top border of the UI can be reduced. Similarly, in the example shown on the right side of FIG. 2A, the image of the depicted person can be cropped such that the white space between the person and the right border of UI can be reduced.

The computing device can minimize or at least reduce a distance between a depicted object and a camera by changing the size of the user interface. For instance, a user interface can be reduced from a full screen configuration to a smaller size to allow a predetermined point of a depicted object, such as a person's eyes, to be positioned closer to the camera. By reducing the size of the user interface, predetermined point of the depicted object and the UI can be moved closer to the camera. In one illustrative example an image, such as a video stream of a person can be configured to take an entire display area, e.g., full screen. When the techniques disclosed herein are activated, e.g., by an input command or any other detected condition, the user interface of the person can be reduced to 25% of the original size in order to move a depicted object closer to the camera. The size can be reduced to a threshold minimum. The threshold minimum can be based on a size of the display screen and/or aspects of the depicted object(s). For instance, a threshold minimum can be based on a number of depicted people, the resolution of an incoming data stream, etc. In one example, a user interface can be reduced to a threshold minimum of 20% when there is only one person depicted in the user interface, but reduced to a threshold minimum of 25% when there is more than one person depicted in the user interface.

The computing device can also minimize or at least reduce a distance between the object depicted in the user interface and the camera by changing the shape of the user interface. For instance, as shown in the first three configurations of FIG. 1, if a user interface includes a number of images, the arrangement of each image can be modified to bring each image as close to the camera position as possible. This can include aligning the renderings along a border of the display screen or clustering the images in a corner of the display screen. As shown in the first configuration, the three renderings are aligned horizontally along the border of the screen. As shown in the second and third configurations, the three renderings are conformed to a corner of the screen to minimize the distance between each rendered object and the camera.

The computing device can minimize or at least reduce a distance between the object depicted in the user interface and the camera by also wrapping a user interface around a camera that is embedded in the screen, as shown in the fifth and sixth configuration of FIG. 1. The fifth configuration can align a particular point of the depicted object, such as a point between a person's eyes, with the camera with an offset to allow the borders of the user interface to remain in the display screen. The sixth configuration can align the center point of the depicted object with the camera without an offset, e.g., offset=0, since the camera 103 is in the center of the screen.

Also shown in FIGS. 2A-2C, a computer can dynamically position a content rendering in response to the rotation of the device. For instance, as shown on the left side of FIG. 2A, when the computer 101 is physically held in an upright orientation, e.g., a portrait orientation, the computer 101 displays the rendered content near the top center of the display screen based on configuration data. The configuration data can indicate a position of a camera relative to a display screen. In one illustrative example, the configuration data can indicate the position of the camera relative to a point of display screen. For instance, the configuration data can indicate that a camera is a particular distance, e.g., 0.5 inches, from the right-top corner of a display screen when a device is held in a portrait orientation. The configuration data can also define how far the camera is from a particular point in the screen, e.g., that a camera is in the center of the screen as shown in the sixth configuration of FIG. 1, that the camera is two centimeters from the top of the screen and one centimeter from the right side of the screen as shown in the fifth configuration of FIG. 1, that the camera is outside of the screen by a particular distance, etc. The device can determine a new location of the camera relative to the display screen based on sensor data determining an orientation of the device and the configuration data.

When the device is rotated to the right and physically held in a side orientation, e.g., a landscape orientation, the computer displays the rendered content near the right-center of the display screen based on the configuration data indicating the position of the camera. In this example, the position of the rendering 109 of the object, e.g., a person, is based on an offset (O) between a point in the rendering, e.g., the person's eyes, and the camera. In this example, the offset can be zero when in the portrait orientation to allow a user of the device to direct their eye gaze toward the camera while looking at a particular point of the rendering. The offset can be another value when in the landscape orientation to allow a user of the device to direct their eye gaze toward the camera while looking at a particular point of the rendering.

As shown on the right side of FIG. 2B, when the computer 101 is physically held in an upright orientation, e.g., a portrait orientation, the computer 101 displays the rendered content near the top center of the display screen based on configuration data. When the device is rotated to the left and physically held in a side orientation, e.g., a landscape orientation, the computer displays the rendered content near the left-center portion of the display screen based on the configuration data indicating the position of the camera. As shown in FIG. 2C, when the computer 101 is physically held in an upright orientation and rotated to the left to an angled position. In such an event, computer displays the rendered content in proximity to the camera at an angled position such that the user interface maintains the same orientation as the original orientation prior to the rotation.

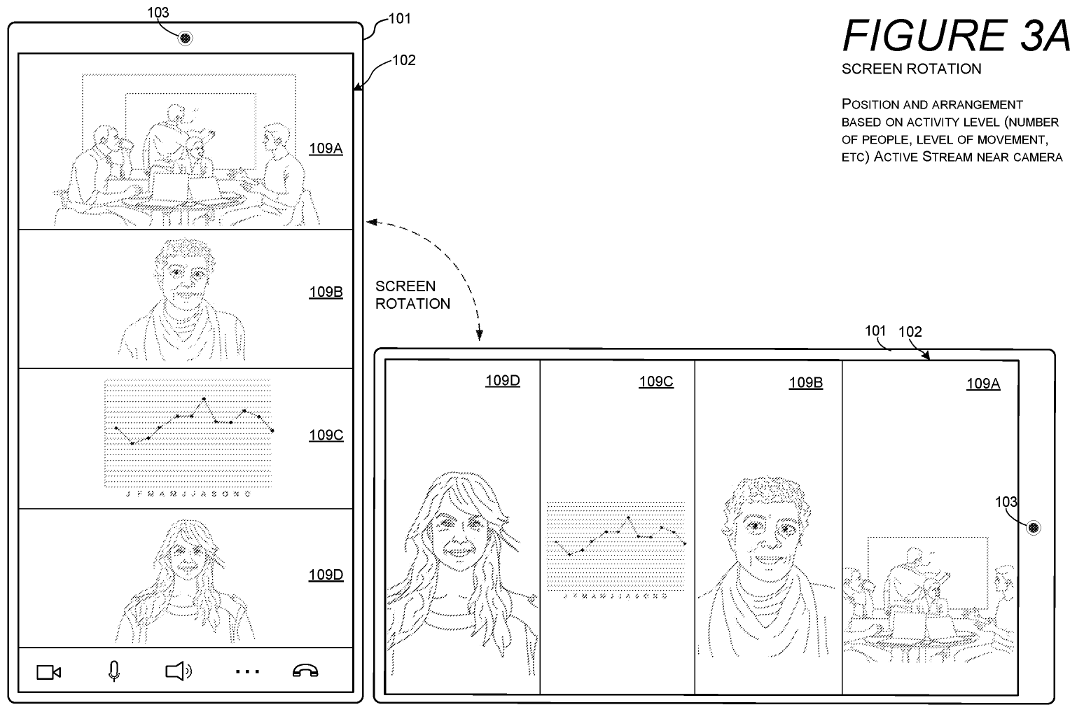

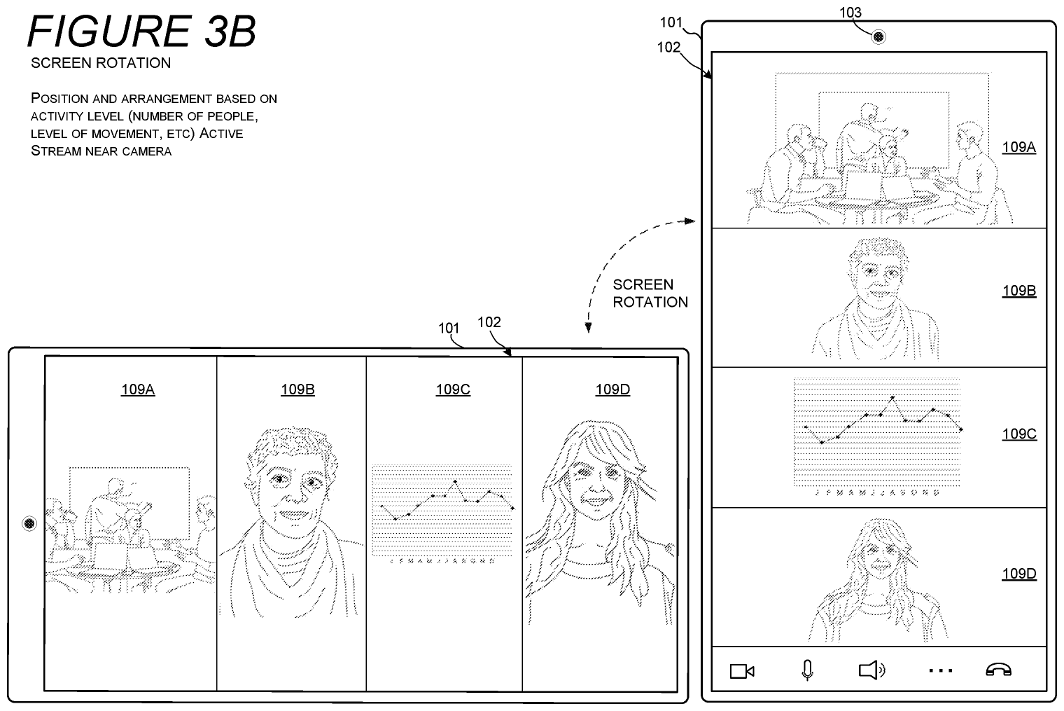

Referring now to FIGS. 3A and 3B, embodiments involving multiple renderings are shown and described below. In such embodiments, a device 101 can display a number of content renderings 109A-109D, which can include video content, image content, or file content. Each rendering can be prioritized based on one or more factors. Then each content rendering 109A-109D can be arranged by the priority with respect to a location of a camera. For instance, as shown in FIG. 3A, a high priority rendering 109A can be positioned near the camera and the remaining renderings 109B-109D can be positioned further away from the camera 103. In some embodiments, the remaining renderings 109B-109D can be ordered by the priority of each rendering, with the lowest priority rendering being furthest from the camera.

In some embodiments, the priorities can be based on a content type, an activity level associated with the content, a priority of an identity of a person depicted in a rendering, a number of depicted people, and/or a combination of factors. The content type can include, but is not limited to, data types, e.g., spreadsheet data, word processing data, still images, recorded video content, live video content, etc. The activity level can be based on a number of factors, such as movement of a person depicted in a rendering, a volume level of a person speaking, a gesture speed of a user, e.g., how fast or how high a person is raising their hand. The identity or role of a depicted person can also be used to indicate a priority for a rendering, such as a CEO having a higher priority than managers, etc.

For illustrative purposes, consider a scenario where a policy indicates that content depicting more than a threshold number of people, e.g., three or more people, has a high priority level, content depicting a person talking or moving has a medium priority level, content depicting a data chart has a low level and content depicting people who are not moving or talking at a lowest level. A device can apply such a policy to an incoming stream and produce the displays shown in FIG. 3A. The first rendering 109A comprises content depicting more than a threshold number of people, e.g., four people being over the threshold, the second rendering 109B depicting a person talking, the third rending 109C depicting a data chart, and a fourth rendering 109D depicting a person who is not moving or talking.

As shown on the left side of FIG. 3A, when the computer 101 is physically held in an upright orientation, e.g., a portrait orientation, the computer 101 displays the highest priority content 109A at the top of the display screen near the camera, and remaining renderings 109B-109D are further from the camera than the highest priority content 109A. In this example, the renderings are ordered by the associated priorities. When the device is rotated to the right and physically held in a side orientation, e.g., a landscape orientation, with the camera to the right side of the screen, the computer displays the highest priority content 109A near the right side of the display screen near the camera, and remaining renderings 109B-109D are further from the camera than the highest priority content 109A. In addition, when the device is rotated to the left, from the landscape orientation portrait orientation, the highest priority content 109A is rendered at the top of the screen 102, where the highest priority content 109A is positioned closer to the camera than the remaining renderings 109B-109D.

FIG. 3B shows the device 101 of FIG. 3A being rotated in the opposite direction. A shown on the left side of FIG. 3B, when the computer 101 is physically held in an upright orientation, e.g., a portrait orientation, the computer 101 displays the highest priority content 109A at the top of the display screen near the camera, and remaining renderings 109B-109D are further from the camera than the highest priority content 109A. In this example, the renderings are ordered by the associated priorities.

When the device is rotated to the left and physically held in a side orientation, e.g., a landscape orientation, with the camera to the left side of the screen, the computer displays the highest priority content 109A near the left side of the display screen near the camera, and remaining renderings 109B-109D are further from the camera than the highest priority content 109A. In addition, when the device is rotated to the right, from the landscape orientation portrait orientation, the highest priority content 109A is rendered at the top of the screen 102, where the highest priority content 109A is positioned closer to the camera than the remaining renderings 109B-109D.

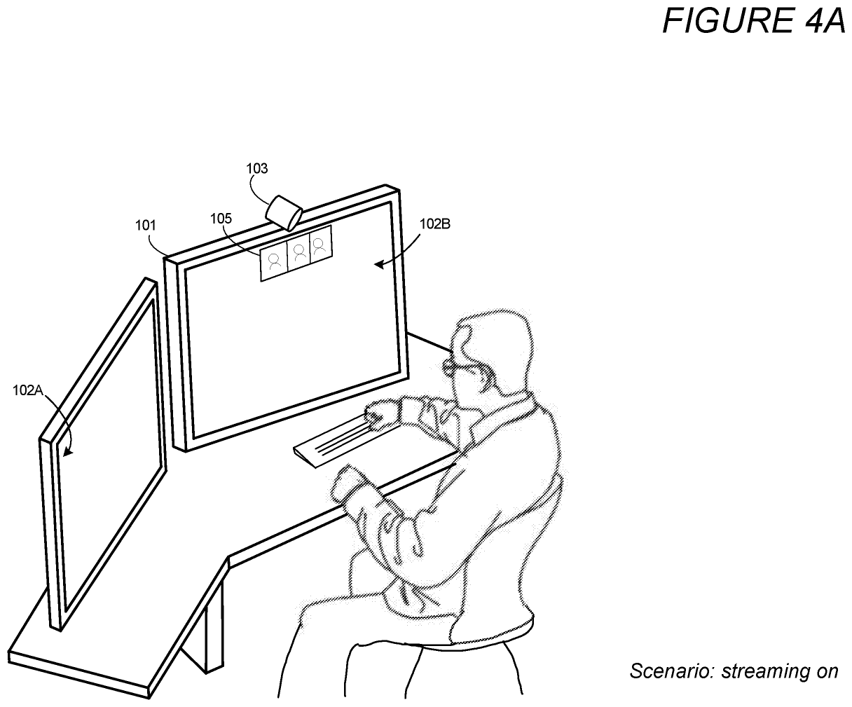

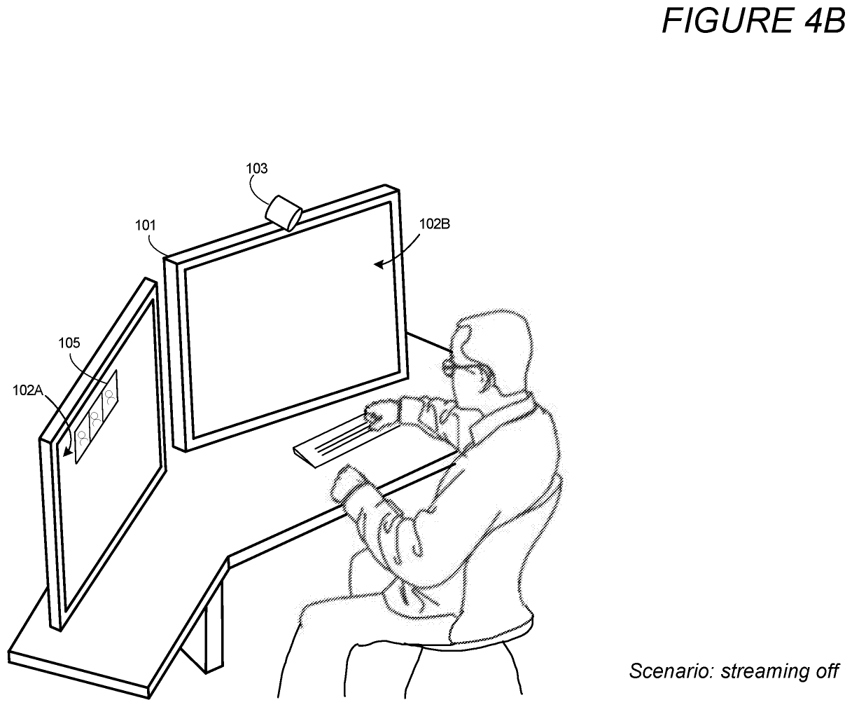

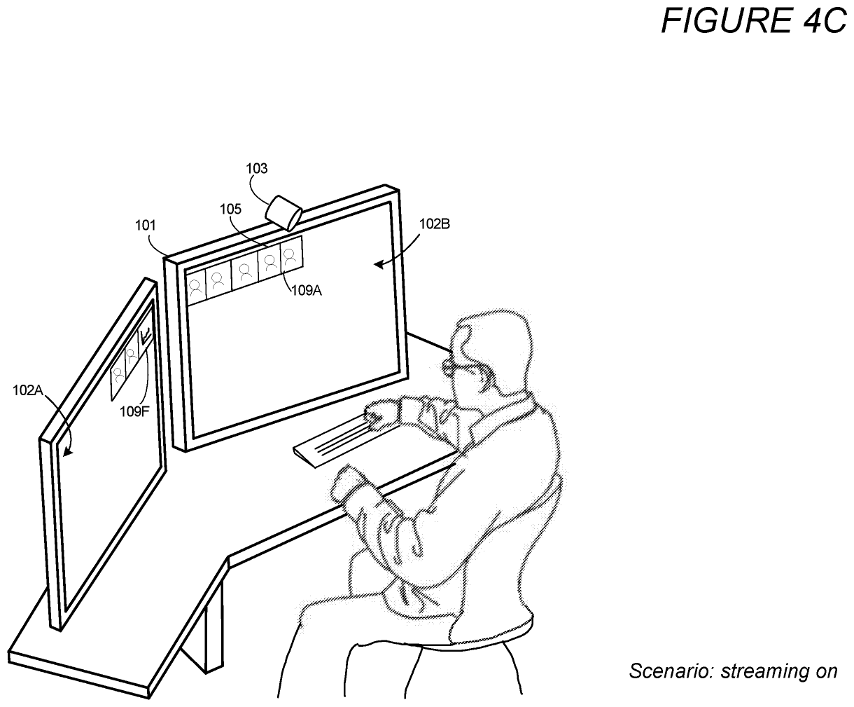

Referring now to FIGS. 4A and 4B, embodiments involving multiple display screens 102 are shown and described below. In such embodiments, as shown in FIG. 4A, the computing device 101 can receive configuration data indicating a position of a camera 103 with respect to each monitor. The configuration data can indicate which display screen is closest to the camera and also indicate a position of the camera relative to the closest display screen. For instance, the configuration data can indicate that the camera is in a top center position of the second display screen 102B. In response to receiving such configuration data, the computer 101 can position a user interface 105 comprising one or more renderings on the second display screen 102B at or near a top-center position of the second display screen 102B. An alignment and/or distance can be determined for the renderings and the user interface 105 relative to the camera as described in the other examples.

In some configurations, the techniques disclosed herein can activate or deactivate the positioning of the user interface with respect to the camera. A user can activate or deactivate the dynamic positioning of the user interface by the use of a user input command or the activation or deactivation or the dynamic positioning of the user interface can be based on other factors, such as whether a camera is turned on or turned off, whether camera is transmitting a signal via an application or not transmitting a signal, etc. For instance, as shown in FIG. 4B, if a user is operating a videoconferencing application is not broadcasting a video stream or if the camera is turned off, the dynamic positioning of the user interface may be deactivated. In such an event, the user interface 105 can be displayed on the first display screen 102A when the user is not broadcasting a video stream or if the camera is turned off or disabled. However, as shown in FIG. 4A, when the user starts to broadcast a video stream through the videoconferencing application, the system can dynamically position the user interface according to the configuration data. In such an event, the computer can dynamically move the user interface 105 from the first display screen 102A to the second display screen 102B when an application starts to broadcast a video stream using the camera, or when the computer otherwise activates the camera.

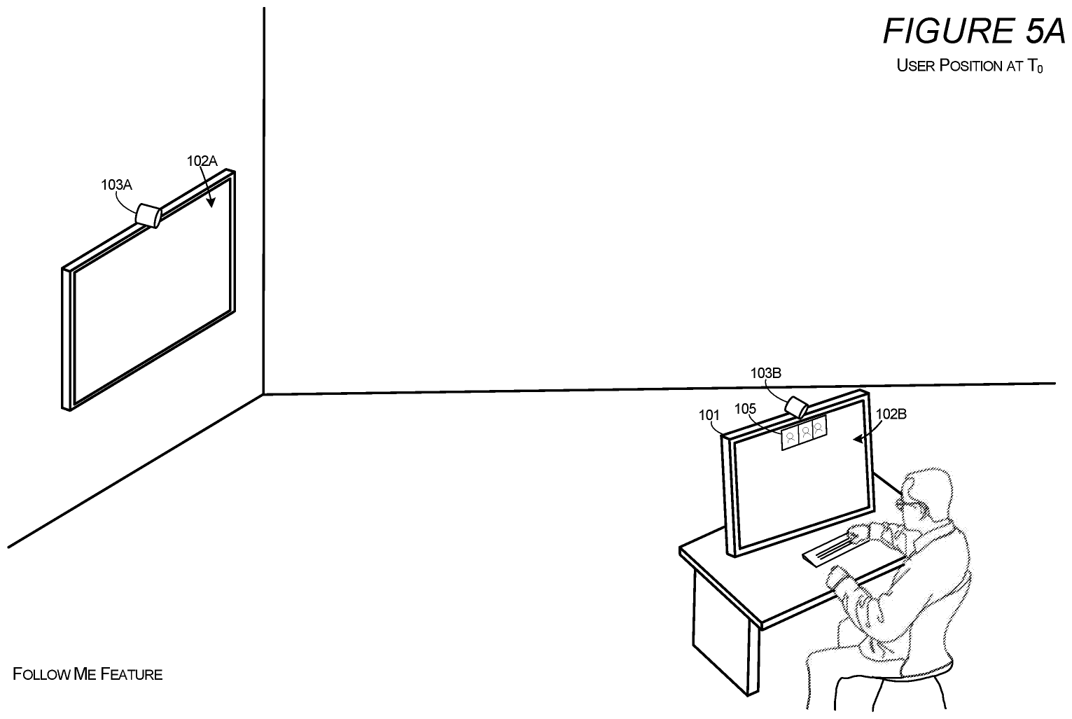

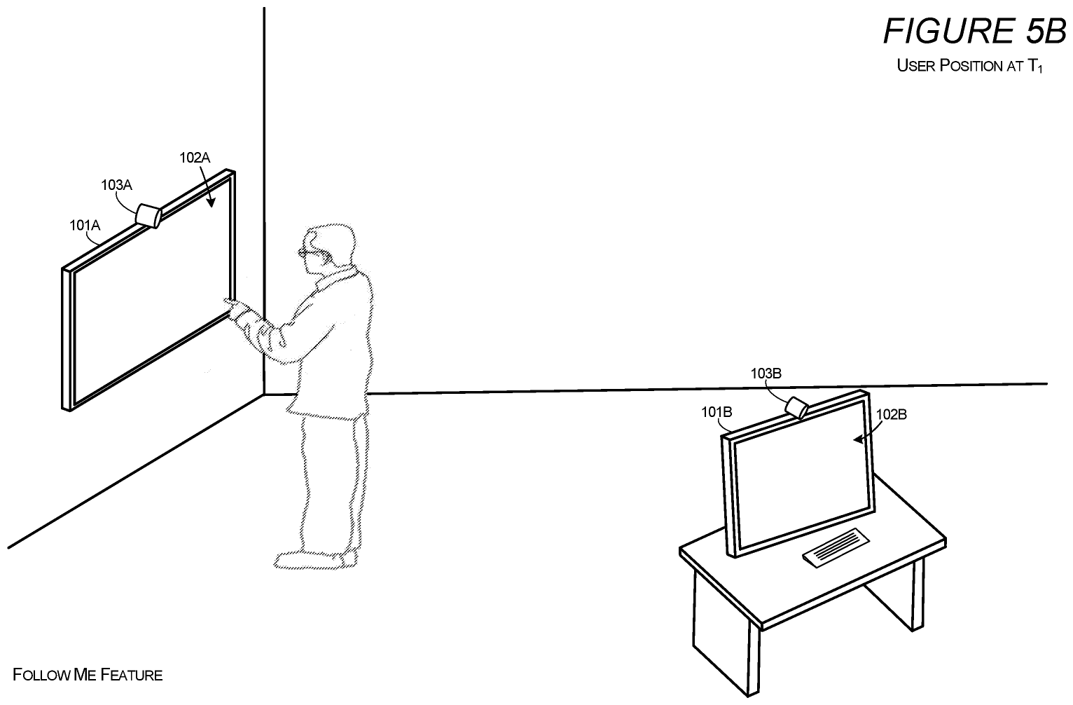

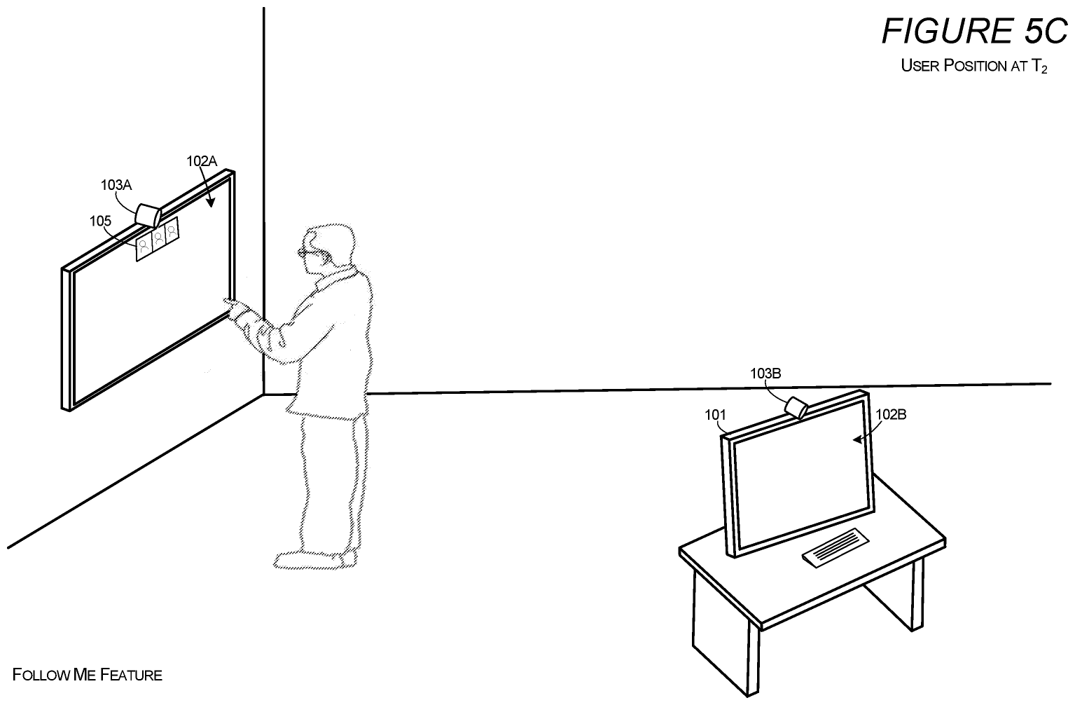

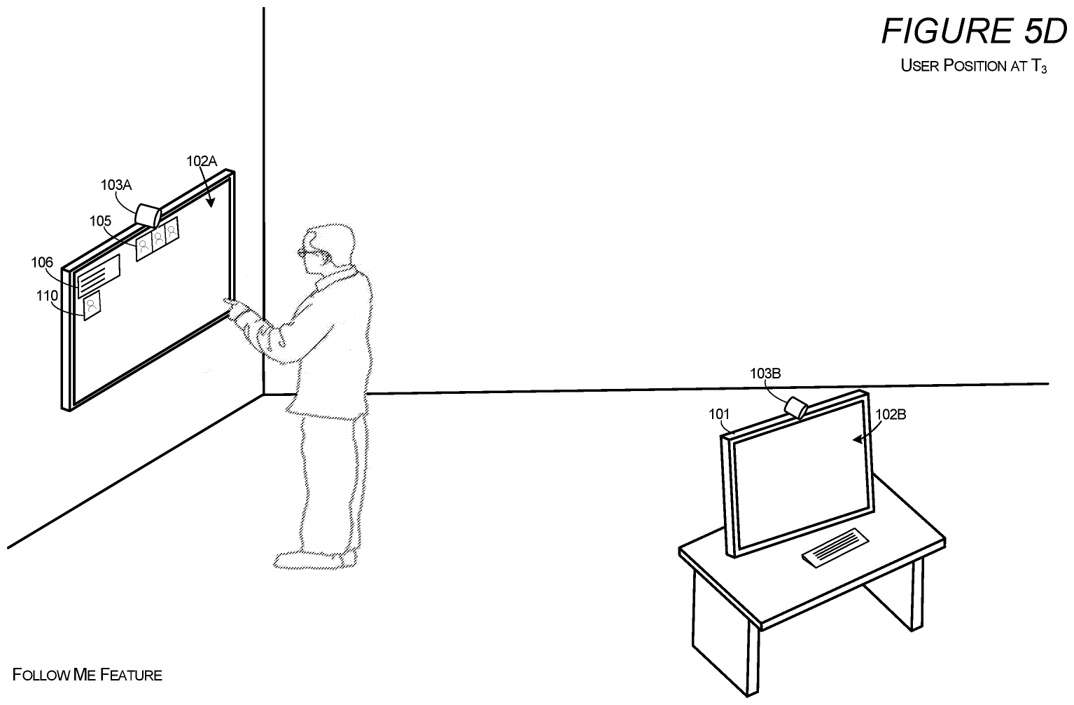

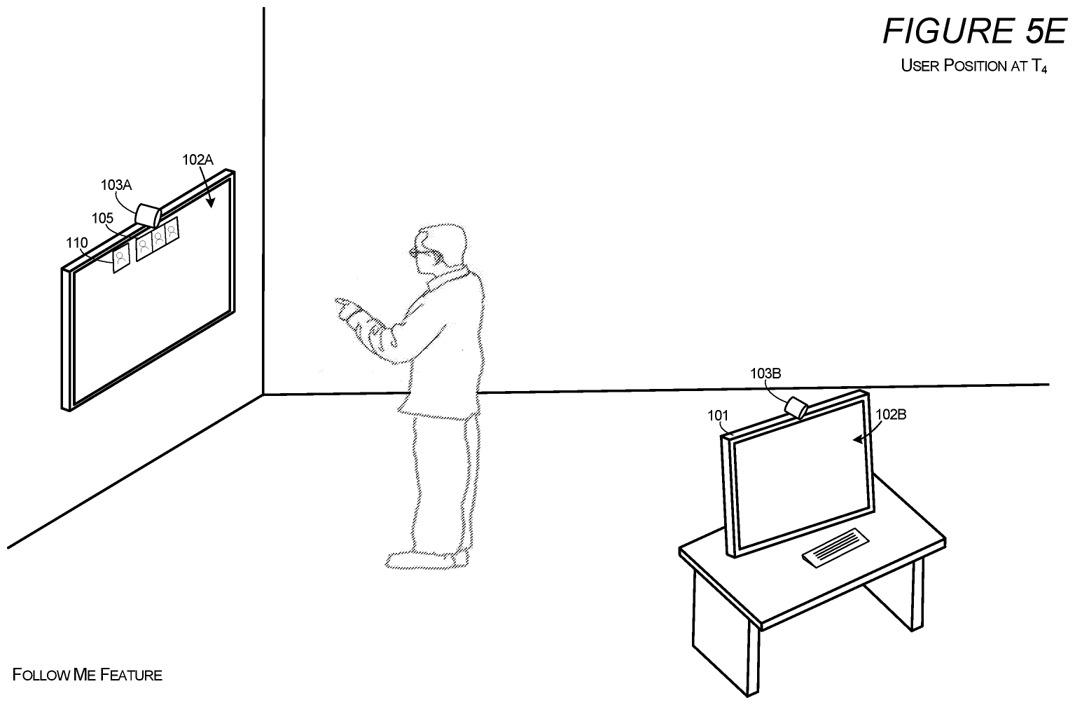

Referring now to FIGS. 5A-5D, embodiments having multiple display screens and multiple cameras to enable a “follow me” feature are shown and described below. In such configurations, a device 101 can monitor a position of a user to determine select a display screen that provides the most optimal view of displayed content. The system also selects a camera that provides an optimal view of the user. A user interface displaying the content is moved to the selected monitor and the selected camera is activated so an audience receiving a video stream from the camera can be engaged with the user while the user is viewing the content. Thus, instead of requiring a user to move a camera, or requiring a user to manually activate specific cameras, the system can track a person's movement and automatically display rendered content on a display screen near a user and also activate a camera near the user to enable the audience to “follow” the user's movement. By tracking a person's movement, the device 101 can maximize the person's engagement with an audience and allow an audience to see the user's gestures.

In one illustrative example, a system can comprise a computing device 101 in communication with a first display screen 102A that is in proximity to a first camera 103A, and a second display screen 102B that is in proximity to a second camera 103B. The cameras can monitor the position of the user. For instance, the computing device can receive sensor data from one or more cameras to determine that the user is in front of the first camera or the second camera.

As shown in FIG. 5A, at time T₀, the computing device 101 displays the user interface 105 comprising one or more renderings on the second display device 102A in response to receiving sensor data that indicates the user is in front of the second display device 102A. In addition, the user interface can be positioned within the second display screen 102A based on configuration data indicating the location of camera relative to the display screen 102A.

Next, as shown in FIG. 5B, at time T₁, one or more cameras detect that the user has moved from the desk to a position in front of the first display device 102A and the first camera 103A. In response to receiving sensor data indicating that the user is in front of the first display device 102A, as shown in FIG. 5C, at time T₂, the computing device 101 moves the display of the user interface from the second display screen 102B to the first display screen 102A. In addition, in response to receiving the sensor data indicating that the user is in front of the first display device 102A the computing device 101 deactivate second camera 103B and activates the first camera 103A for sharing a video stream with one or more remote computing devices. By dynamically moving rendered content to a display screen that is near a user, and by dynamically activated camera that is also near user, the system can enable the user to view the rendered content while providing more direct gestures to an audience receiving a video stream generated by the system.

The follow-me feature can also be based on other contextual data regarding the user. For instance, in addition to sensor data indicating movement of user, the system can move the user interface to a selected display device and/or select a second camera for transmitting video data based on one or more user inputs. In one illustrative example, a user interface or a rendering can moved from a first screen to a second screen based on a cursor movement that has moved from the first screen to the second screen. In other embodiments, a user interface or a rendering can be moved from a first screen to a second screen based on a voice command indicating a movement of a user or by any other input indicating a movement or indicating an intent of a movement.

FIGS. 5C-5E illustrate an example involving a notification that can guide a user to a position that optimizes a camera angle and/or optimizes an audio signal. For instance, as shown in FIG. 5C, at Time T₂, the system may receive a signal from a sensor and determine that the user's position is not producing a camera angle, light level or audio signal that meets one or more threshold conditions. For instance, if the user is standing too close to the camera, the user may not be providing the most optimal view for an audience receiving his or her video stream. The system can detect whether a camera is not capturing a full perspective of the user's face or if the user is not turned towards the camera for allowing users to see all facial gestures. If user standing too close or too far from a microphone, the user may not be enabling the system to produce an audio stream having a threshold level of quality. The system can then determine a location that can improve the camera angle, a light level and/or an audio signal. As shown in FIG. 5D, at Time T₃, the system can provide a notification 106 instructing the user to move to a location that is optimal for improving the camera angle and/or the audio signal associated with the user. In addition, the system can also cause a display of a preview 110 of the video stream that is communicated from the camera 103 to the remote devices. The preview 110 can be displayed on a display screen, such as the first display screen 102A, and indicate any type of issue with the video stream, such as a lighting issue, a cropped view of the presenter, a description of an audio issue, etc. This preview helps the user make further adjustments to his or her position to optimize aspects of the outgoing video and audio stream.

In some configurations, the system can include one or more sensors, such as microphones, depth sensors, or cameras. The sensors can be utilized to monitor the volume of a person at various locations. The system can monitor volume levels over time and identify volume levels of the user that are within a threshold range. The system records locations of the user that are associated with a time when the volume levels of the user that are within a threshold range. When the volume level is below or above the threshold range, the system can generate a notification, such as the graphical element 106 or a computer-generated voice instruction, indicating a location where volume levels of the user were recorded as being within the threshold range.

The techniques disclosed herein apply to adjustments for light levels. The system records locations of the user that are associated with a time when the light levels reflected from the user are within a threshold range. In addition, the system can analyze the light levels reflected from a user as they move around the room to determine if a light level is above or below a threshold range. When the light level is below or above the threshold range, the system can generate a notification, such as the graphical element 106 or a computer-generated voice instruction, indicating a location where light levels of the user were recorded as being within the threshold range.

In addition, the system can analyze the video stream produced by the user and determine if the user's face is not aligned with the camera. For example, if the system detects that the lower half of the user's face is not captured by the camera, the system can notify the user to change his or her position until the user's entire face is captured by the camera. This improves the accessibility of the system, as some audience members receiving the user stream may utilize lip reading techniques. As shown in FIG. 5E, at time T₄, once the user receives the notification 106, the use can move to a recommended location that produces an optimal camera angle, light levels, and/or audio signal. In some embodiments, the system can also maintain the display of a preview 110 while the user is making adjustments to his or her position. The preview 110 can be displayed for a predetermined period of time or until the user has moved to a position that produces at least one of a light level, an audio quality level, and/or a score of a camera angle that are within one or more threshold ranges, e.g., that the communication stream properties are within predetermined levels.

For illustrative purposes, at least one of a light level, audio quality level, and/or a score of a camera angle are considered to meet one or more criteria when one of these values fall below a desired threshold or exceed one or more desired thresholds. In other words, a computer can take an action to instruct a user to move positions if the light is too bright or too low, or if a sound volume is too low, or if a noise level is too high, or if a camera angle score falls below a threshold. The notification can provide an instruction to tell a user to move to a new position, which can include actions such as standing up, sitting down, moving their head to a particular position, moving to a new location with an room, etc.

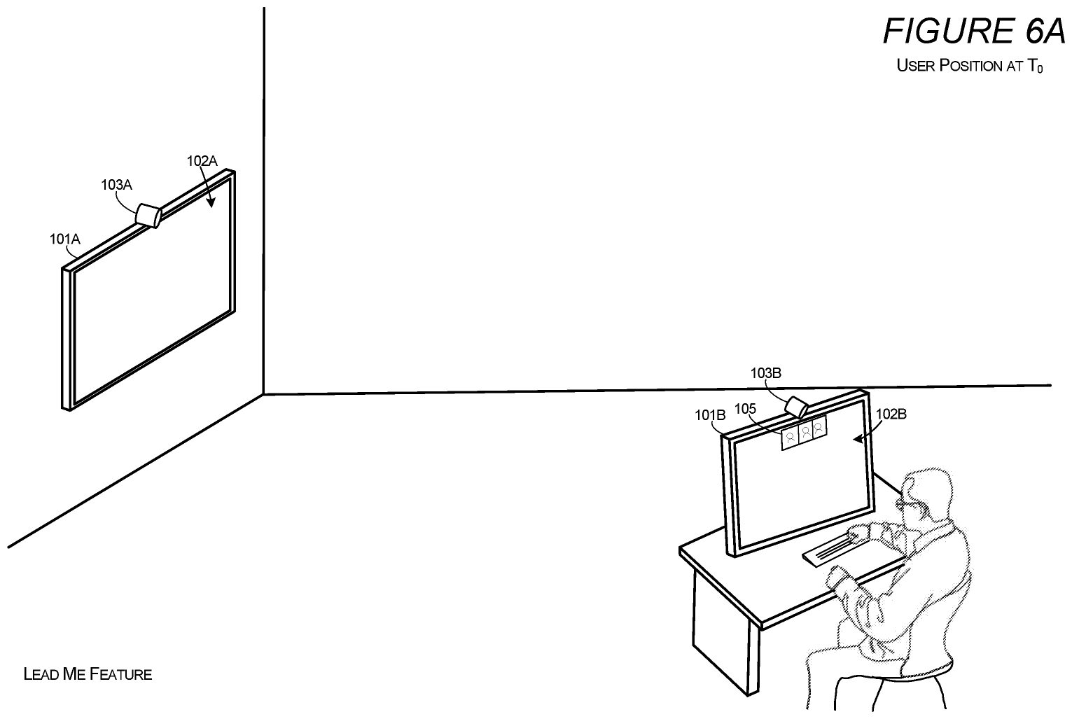

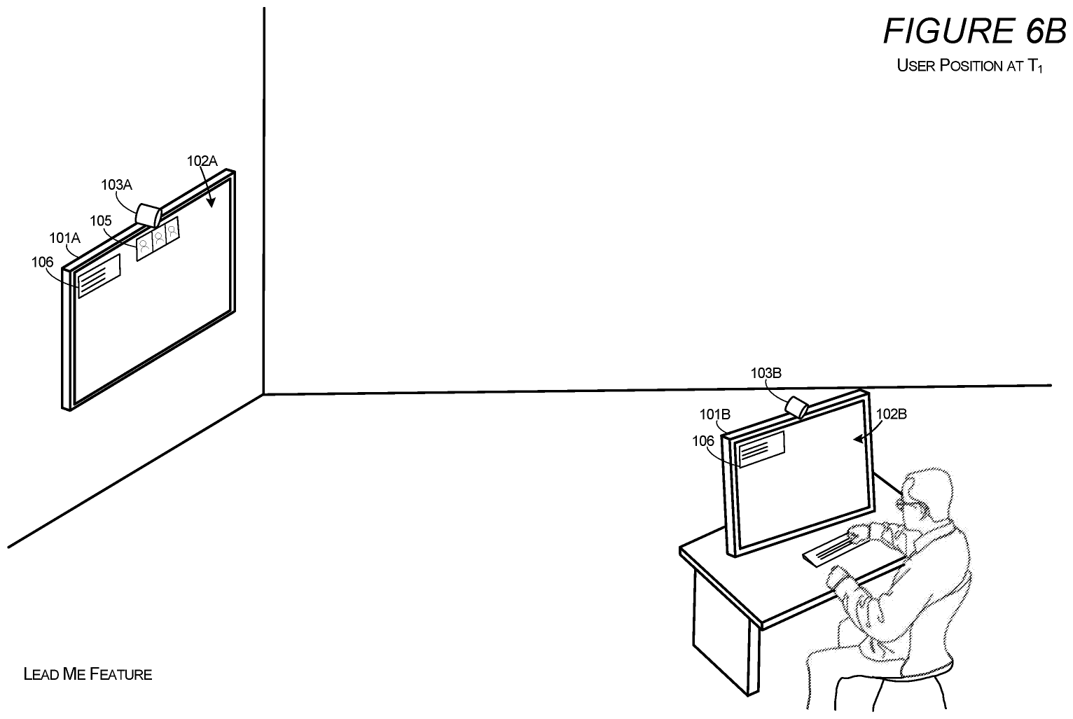

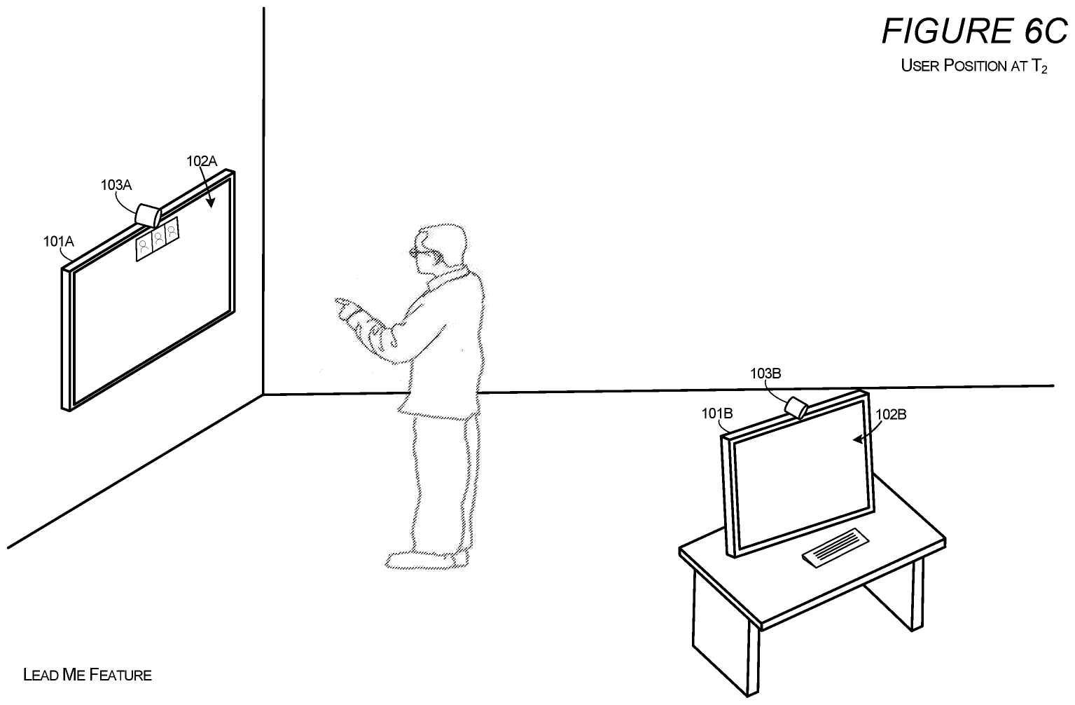

Referring now to FIGS. 6A-6C, embodiments of a system having multiple display screens and multiple cameras for enabling a “lead me” feature are shown and described. In such configurations, the system can keep a record of positions of presenters that provide optimal camera angles, lighting, and audio signals. When a user starts to stream a presentation from a camera, the system can provide suggestions of where the user can move to optimize, light, camera angle and/or sound quality of a video stream of the user. In some configurations, the suggestions can be in the form of a user interface that moves content to a different display screen to lead a user to a new position or location to optimize characteristics of a stream generated by a camera and proximity to the display screen. The system can display content at a specific location within a selected display screen so an audience receiving a video stream from the camera can be engaged while the user is viewing the content.

In one illustrative example, a system can comprise a computing device 101 in communication with a first display screen 102A that is in proximity to a first camera 103A, and a second display screen 102B that is in proximity to a second camera 103B. The cameras can monitor the light levels, audio quality, and/or camera angles that are within a threshold range. The system records locations of the user that are associated with a time when the light levels, audio quality, and/or camera angles. The system can then monitor light levels, audio quality, and/or camera angles of user when a user is in particular position with respect to the camera. When the light levels, audio quality level, and/or a score of associated camera angles are below or above the threshold range, or a threshold, the system can generate a suggestion, such as the graphical element 106 or a computer-generated voice instruction, indicating a location where the light levels, audio quality, and/or camera angles. An audio quality level can be a volume level, a noise ratio level, a clarity level, etc.

As shown in FIG. 6A, at time T₀, the computing device 101 displays the user interface 105 comprising one or more renderings on the second display device 102A. This display of the user interface can be in response to receiving sensor data that indicates the user is in front of the second display device 102A. In addition, the user interface can be positioned within the second display screen 102A based on configuration data indicating the location of camera relative to the display screen 102A. While streaming video data from the camera, the system monitors light levels, audio quality, and/or camera angles of the user.

When the light levels, audio quality, and/or a score of associated camera angles are below or above the threshold range, as shown in FIG. 6B, at time T₁, the system can determine a position for the user the light levels, audio quality, and/or camera angle scores meet one or more thresholds. In response to determining the position for the user, the system can also select a display screen, such as the first display screen 102A, that is in proximity to the determined position. In addition, in response to determining the position for the user, the system can cause the user interface 105 to be positioned within the second display screen 102A based on configuration data indicating the location of camera relative to the display screen 102A. The system can also cause the display of a suggestion, such as the graphical element 106 or a computer-generated voice instruction, indicating a specific position for the user. For instance, a suggestion can tell a person where to stand or sit and a direction where to project their voice. The graphical element 106 can be displayed at any display screen, such as the first display screen 102A and/or the second display screen 102B. The graphical element 106 be displayed for a predetermined time or be displayed until the system detects that the user has moved from a particular display screen. For instance, if the user moves from the second display screen 102B to the first display screen 102A, the system may cause the removal of the graphical element 106 from the second display screen 102B. The graphical element 106 comprising the recommendation of where to move can be displayed on either or both computing devices depending on where the user is located or based on other detected conditions. For instance, the graphical element 106 can start on the second screen 102B and move to the first screen 102A as the user moves from the second screen 102B to the first screen 102A.

As shown in FIG. 6C, at time T₂, in response to the user interface moving between display screens, the user can move from a first position to a second position to follow the user interface. When the user follows the user interface to a new position, the system can optimize the light levels, audio quality, and/or camera angle scores associated with video data generated from the camera and one or more associated microphones.

The embodiments described above and shown in FIGS. 6A-6C can also include features for identifying optimal hardware for specific user tasks. For instance, the system can monitor user activity and determine an activity type. An activity type can include using an inking device to draw digital ink, using a keyboard for entering text data, using a microphone for speech to text input, etc. Based on the activity type, the system can select a display screen that is optimized for the activity type. To facilitate such embodiments, a system can keep a database or define a policy that associates different activity types to different types of display screens. In one example, an inking activity can be associated with a digital whiteboard, such as the first display 102A. When the system detects that user is using a mobile device to draw digital ink, based on the policy, the system may generate a recommendation that the user move to a particular display screen, such as the first display screen 102A, to complete the detected activity. The system can then move the user interface 105 of the rendered content to the first display screen 102A and also activate a camera associated with the first display screen 102A in response to the detection of the activity type.

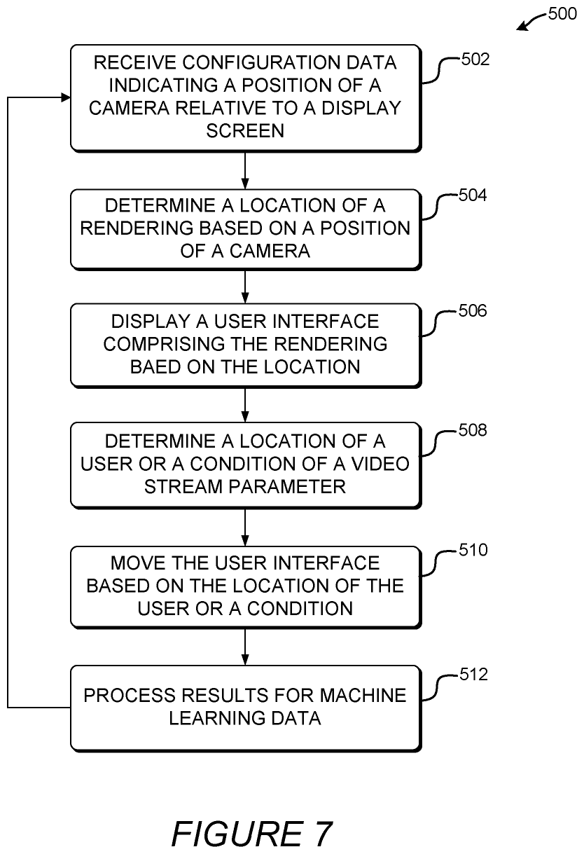

Turning now to FIG. 7, an example routine 500 for the dynamic positioning of content views based on a camera position relative to a display screen is shown and described below. These routines can be utilized separately or in combination in any order. It should be understood that the operations of the methods disclosed herein are not presented in any particular order and that performance of some or all of the operations in an alternative order(s) is possible and is contemplated. The operations have been presented in the demonstrated order for ease of description and illustration. Operations may be rearranged, added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the example routines are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the management engine 134 for performing the techniques disclosed herein, it can be appreciated that the operations of the example routines may be also implemented in many other ways. For example, the example routines may be implemented, at least in part, by a processor of another remote computer or a local computer. In addition, one or more of the operations of the example routines may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

With reference to FIG. 7, a routine 500 for automatically clustering users based on identities provided by a user is shown and described. The routine begins at operation 502 where the management engine 134 receives configuration data 622 indicating a position of a camera 103 relative to a display screen 102 in communication with the computing device 101. In one illustrative example, the configuration data can indicate the position of the camera relative to a point of display screen. For instance, the configuration data can indicate that a camera is a particular distance, e.g., 0.5 inches, from the right-top corner of a display screen when a device is held in a portrait orientation. The configuration data can also define how far the camera is from a particular point in the screen, e.g., that a camera is in the center of the screen as shown in the sixth configuration of FIG. 1, that the camera is three centimeters from the top of the screen and 2 centimeters from the right side of the screen as shown in the fifth configuration of FIG. 1, that the camera is outside of the screen by a particular distance, etc. The device can determine a new location of the camera based on sensor data determining an orientation of the device and the configuration data.

Next, at operation 504, the management engine 134 analyzes the configuration data 622 to determine a location for a graphical user interface 105 displaying content of the communication session 604. The location of the graphical user interface 105 is based on the position of the camera 103 relative to the display device 102. As described herein, a computing device can determine a location for a graphical user interface or a location for a rendering. The position of the graphical user interface or the rendering can be positioned in proximity to a camera. In some configurations, a distance between a rendering and a camera can be minimized while maintaining a threshold percentage of the rendering within a display area. In some configurations, a particular point within a rendering, such as a center point between a depicted person's eyes, can have a distance from a camera. The distance can be minimized to a minimum threshold. The minimum threshold can be determined by a size of a rendering. For instance, a large rendering of a person's face may have a larger minimum threshold than a smaller rendering of the person's face, thus allowing the face to be displayed within the display area without being cropped. Other factors described herein can also control a location of a graphical user interface or a location of a rendering.

Next, at operation 506, the management engine 134 causes a display of a user interface comprising the rendering based on the determined location. For example, as shown in FIG. 2A, a user interface 105 can comprise a rendering 109 that has one or more location parameters that is determined from the configuration data indicating a location of a camera relative to a display screen. FIG. 3A illustrates another example where a select rendering is displayed in proximity to a camera based on the configuration data indicating a location of a camera relative to a display screen. In this embodiment, other renderings that are not selected, or do not have a threshold priority, are positioned further from the camera then the selected rendering. In other examples, a system may select a display screen from a plurality of display screens based on one or more factors, including the location of a user or a location that is based on a particular level of lighting, sound quality, or camera angle associated with the location.

Next, at operation 508, the management engine 134 can determine a location of the user or detect a condition of a video stream parameter. In some configurations, a system can use one or more sensors to determine a location of the user. The system can then position or move a rendering within a display screen or between different display screens based on the location of the user. The system can also select a camera or move a camera to follow the user to allow the user to view rendered content while maintaining eye contact with the camera.

In some configurations, operation 508 can also include the detection of one or more stream parameters. A stream parameter can include a lighting level, a volume level, and/or the score associated with a camera angle. A score can be calculated based on a number of parameters. For instance, a score associated with camera angle can be increased if the camera angle enables a camera to generate video data that depicts the person's face. The score can be reduced if the camera angle enables the camera to only capture a portion of the face. The score can be increased if a camera angle enables a camera to capture a person's eyes or mouth. This scoring model enables a system to make recommendations for user to move into locations or positions to increase the quality of a video stream of a person. In particular, if the system is able to suggest that a person move into a camera view to show lip movement and other gestures to help an audience who relies on lip reading techniques.

Next, at operation 510, the management engine 134 can move the user interface from one display screen to another based on a determined location. The determined location can be based on a person's movement to a location. In some embodiments, the determined location can be based on historical data indicating locations that have produced threshold levels of light, sound quality, and/or camera angle scores.

Next, at operation 512, the management engine 134 can process results from one or more user responses for generating machine learning data to be used in future iterations of the routine 500. For instance, if various locations produce optimal parameters with respect to a stream, such as a lighting level, volume level, or a score associated with the camera angle, such locations are stored for future iterations of the routine. Each time the routine is executed, scoring data can be updated and/or weighted based on the quality of stream data generated by a system. In addition, machine learning data can also be generated by input data provided by user. For instance, if a user indicates that a certain camera angle is optimal for an audience, such data is stored and utilized for future iterations of the routine for making recommendations and/or suggestions as described herein.

In some configurations, the routine 500 determines a location for displaying a conference view depending on a position of a camera used in capturing video of the user for the conference. For example, a computer-implemented method for guiding an eye gaze direction of a user toward a camera 103 generating video data for transmission to remote devices participating in a communication session 724, the computer-implemented method for execution on the computing device 101 comprising a number of operations that includes receiving configuration data 622 indicating a position of the camera 103 relative to a display screen 102 in communication with the computing device 101, analyzing the configuration data 622 to determine a location for a graphical user interface 105 displaying a rendering of content, wherein the location of the graphical user interface 105 is based on the position of the camera 103 relative to the display screen 102; and causing a display of the graphical user interface 105 on the display screen 102 at the determined location causing the graphical user interface 105 to be displayed in proximity to the camera 103 for allowing the user to view the content while guiding the eye gaze direction of the user toward the camera 103.

In some configurations, as shown in FIGS. 2A-2C, a physical rotation of the device moves the user interface to a location near the camera. Thus, the routine can also include operations receiving orientation data from a sensor mounted to the computing device, the orientation data indicating a rotation of the display screen from a first physical orientation to a second physical orientation; in response to determining that the display screen has rotated from the first physical orientation to the second physical orientation, analyzing the configuration data to determine a second location for the graphical user interface based on the position of the camera relative to the display screen while the computing device is in the second physical orientation; and moving the graphical user interface to the second location for allowing the user to maintain the view of the content while the second position of the graphical user interface continues to guide the eye gaze direction of the user toward the camera.

In some configurations, as shown in FIGS. 4A-4C, in a multi-screen device, the computer selects the screen that is closest to the camera. Thus, the configuration data can also indicate that the display screen is closer to the camera than at least one other display screen in communication with the computing device, where the computer-implemented method further comprises: selecting the display screen for the display of the graphical user interface in response to determining that the display screen is closer to the camera than the at least one other display screen.

In some configurations, as shown in FIGS. 4A-4B, in a multi-screen device, the UI is moved from one screen to another screen that is closer to the camera when a communication stream to the remote devices is activated. Thus, the routine can also include operations wherein the configuration data indicates that the display screen is closer to the camera than at least one other display screen in communication with the computing device, and wherein the computer-implemented method further comprises: initially displaying the graphical user interface on the at least one other display screen; and in response to determining that the video data has begun transmission to the remote devices participating in the communication session, moving the graphical user interface from the at least one other display screen to the display screen at the determined location based on the configuration data.

In some configurations, as shown in FIGS. 4A-4B, in a multi-screen device, the UI is moved to another screen when the stream transmission is deactivated. The system can move the content to a preferred screen away from the camera when not engaged with a communication session. Thus, the routine can also include operations wherein the configuration data indicates that the display screen is closer to the camera than at least one other display screen in communication with the computing device, wherein the computer-implemented method further comprises: in response to determining that the video data stops transmission to the remote devices participating in the communication session, moving the graphical user interface from the display screen to the at least one other display screen.

FIG. 4C illustrates a multiscreen scenario where the user interface 105 crosses multiple display screens 102. In this example, the renderings can be arranged as described above with respect to FIGS. 3A and 3B. Content having a particular type, such as a video of a person shown in the first rendering 109A, can be displayed closer to a camera while other content types, such as a spreadsheet chart shown in the sixth rendering 109F, can be displayed further from the camera than the first rendering. Such arrangements can allow users to utilize both screens but also display content that's most pertinent to that user displayed near the camera. As summarized above, priorities for individual renderings can be based on activity levels, content types, the number of people depicted in a video stream, etc.

In some configurations, as shown in FIGS. 5A-5C, in a multi-screen device and multi-camera system, the UI follows the movement of the user to different screens. Thus, the routine can also include operations wherein the configuration data indicates a position of a second camera relative to a second display screen in communication with the computing device, wherein the computer-implemented method further comprises: receiving sensor data from the camera or the second camera indicating that the user has moved to closer to the second camera than the camera; and in response to determining that the user has moved to closer to the second camera than the camera, moving the graphical user interface to the second display screen from the display screen, wherein the graphical user interface is positioned at a second location on the second display screen according to configuration data, wherein the second location allows the user to view the content on the second screen while guiding the eye gaze direction of the user toward the second camera.

In some configurations, as shown in FIGS. 5A-5C, the system can recommend a location for the user to optimize the video and/or audio stream. Thus, the routine can also include operations further comprising: in response to determining that at least one of a light level, an audio quality level, or a score of an associated camera angle meet one or more criteria, generating a notification instructing the user to move to a position that enables the computing device to generate video data or corresponding audio data having at least one of the light level, the audio quality level, or the score of an associated camera angle within one or more thresholds.

In some configurations, as shown in FIGS. 6A-6C, the system can recommend a location for the user to optimize the video and/or audio stream. Thus, the routine can also include operations where, in response to determining that at least one of a light level, an audio quality level, or a score of an associated camera angle meet one or more criteria, determine a recommended position for the user that enables the computing device to generate video data and corresponding audio data having at least one of the light level, the audio quality level, or the score of an associated camera angle within one or more thresholds; determining a selected camera from a plurality of cameras and a selected display screen from a plurality of display screens based on the recommended position; and activating the selected camera to transmit the video data to the remote devices participating in the communication session; and moving the graphical user interface from the display screen to the selected display screen.

In some configurations, as shown in FIGS. 3A-3C and other examples disclosed herein, the system can position individual renderings relative to other renderings instead of positioning a UI with a frame. The renderings can be arranged to position a selected rendering, e.g., one selected by a user or an activity level, such that the selected rendering is closer to the camera than other renderings that are not selected or not having a priority as high as the selected rendering. A computing device 101 can be configured for guiding an eye gaze direction of a user toward a camera 103 generating video data for transmission to remote devices participating in a communication session 724, the computing device 101 comprising: one or more processing units 802; and a computer-readable storage medium 804 having encoded thereon computer-executable instructions to cause the one or more processing units 802 to perform a method comprising receiving configuration data 622 indicating a position of the camera 103 relative to a display screen 102 in communication with the computing device 101; analyzing the configuration data 622 to determine a location for a selected content rendering 109A of a plurality of content renderings 109A-109D, wherein the location of the selected content rendering 109A is based on the position of the camera 103 relative to the display screen 102; and causing a display of the selected content rendering 109A on the display screen 102 at the determined location causing the selected content rendering 109A to be displayed in proximity to the camera 103 for allowing the user to view the selected content rendering 109A while guiding the eye gaze direction of the user toward the camera 103. The method can also include an operation for determining an arrangement for the plurality of content renderings, wherein the arrangement positions the selected content rendering closer to the camera than the remaining renderings of the plurality of content renderings.

The system can order the renderings at positions relative to a camera according to an ordering based on a priority for each rendering. Thus the method can also include determining a priority for each of the plurality of content renderings; and determining an arrangement for the plurality of content renderings, wherein the arrangement positions the plurality of content renderings according to the priority for each of the plurality of content renderings, where a highest priority content rendering is the selected content rendering and the remaining renderings are at a distance to the camera based on the priority for each of the remaining renderings.

A physical rotation of a device or screen can move the selected rendering to a location near the camera. Thus, the method can further comprise receiving orientation data from a sensor mounted to the computing device, the orientation data indicating a rotation of the display screen from a first physical orientation to a second physical orientation; in response to determining that the display screen has rotated from the first physical orientation to the second physical orientation, analyzing the configuration data to determine a second location for the selected content rendering based on the position of the camera relative to the display screen while the computing device is in the second physical orientation; and moving the selected content rendering to the second location for allowing the user to maintain the view of the content while the second position of the selected content rendering continues to guide the eye gaze direction of the user toward the camera.

In some configurations, the system selects one of the renderings to be closest to the camera based on one or more factors. For example, the computing device can determine the selected content rendering to be closest to the camera based on an activity level associated with the selected content rendering, the activity level is based on at least one of a number of people depicted in the selected content rendering, a data type of the selected content rendering, or a volume level of an audio stream associated with the selected content rendering.

In a multi-screen device, a UI is moved from another screen to the screen closer to the camera when a communication stream to the remote devices is activated. Thus, the configuration data can indicate that the display screen is closer to the camera than at least one other display screen in communication with the computing device, wherein the method further comprises: initially displaying the selected content rendering on the at least one other display screen; and in response to determining that the video data has begun transmission to the remote devices participating in the communication session, moving the selected content rendering from the at least one other display screen to the display screen at the determined location based on the configuration data.

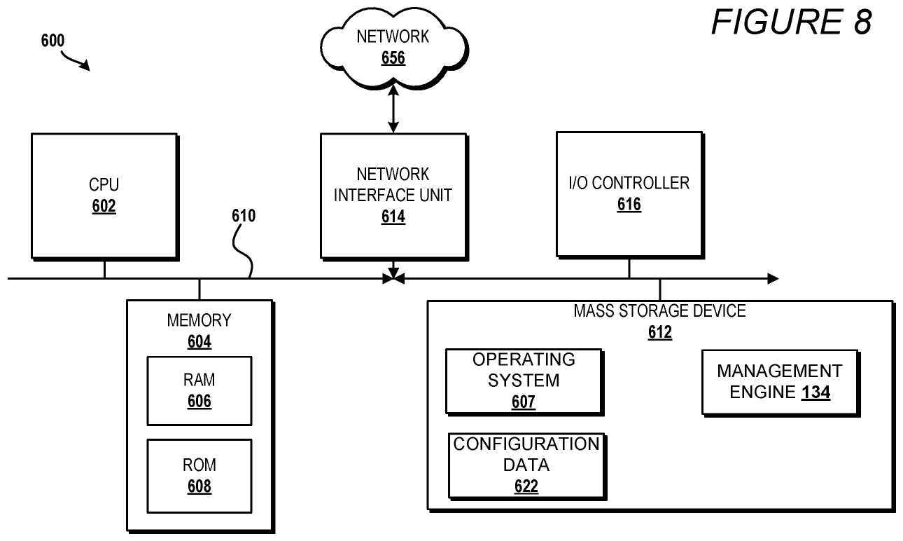

FIG. 8 shows additional details of an example computer architecture 600 for a computer, such as the computing device 101 of the other figures, capable of executing the program components described herein. Thus, the computer architecture 600 illustrated in FIG. 8 illustrates an architecture for a server computer, a mobile phone, a PDA, a smart phone, a desktop computer, a netbook computer, a tablet computer, and/or a laptop computer. The computer architecture 600 may be utilized to execute any aspects of the software components presented herein.

The computer architecture 600 illustrated in FIG. 8 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing an operating system 607, other data, such as the configuration data 622, and one or more applications, such as the management engine 134 that can perform the techniques disclosed herein.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, the phrase “computer storage medium,” “computer-readable storage medium” and variations thereof, does not include waves, signals, and/or other transitory and/or intangible communication media, per se.

According to various configurations, the computer architecture 600 may operate in a networked environment using logical connections to remote computers through the network 656 and/or another network (not shown). The computer architecture 600 may connect to the network 656 through a network interface unit 614 connected to the bus 610. It should be appreciated that the network interface unit 614 also may be utilized to connect to other types of networks and remote computer systems. The computer architecture 600 also may include an input/output controller 616 for receiving and processing input from a number of other devices, including a keyboard, mouse, or electronic stylus (not shown in FIG. 8). Similarly, the input/output controller 616 may provide output to a display screen, a printer, or other type of output device (also not shown in FIG. 8).

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 8, may include other components that are not explicitly shown in FIG. 8, or may utilize an architecture completely different than that shown in FIG. 8.

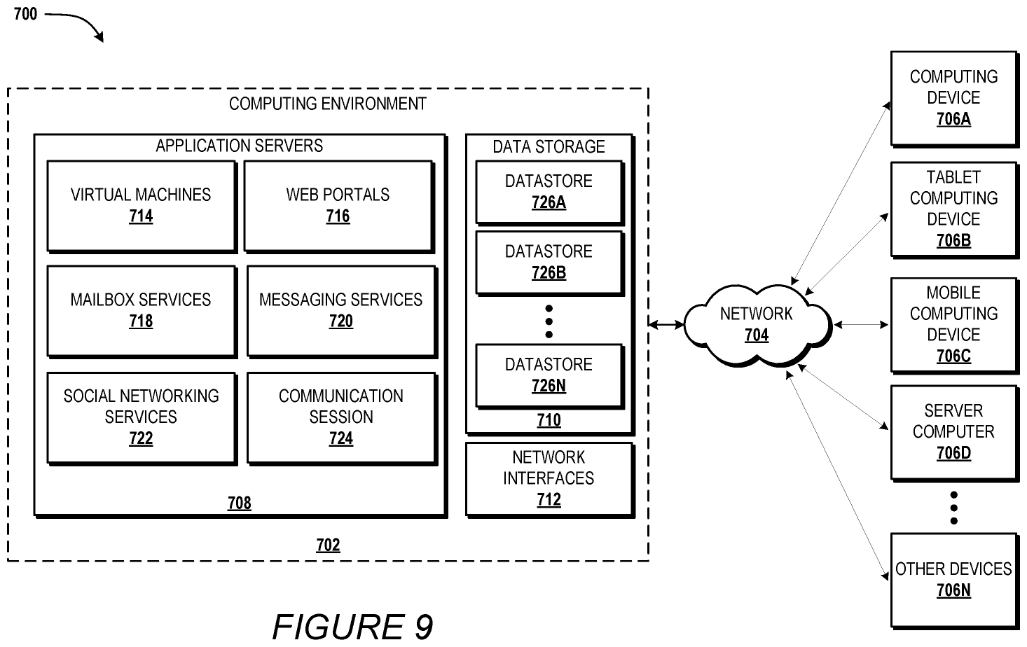

FIG. 9 depicts an illustrative distributed computing environment 700 capable of executing the software components described herein. Thus, the distributed computing environment 700 illustrated in FIG. 9 can be utilized to execute any aspects of the software components presented herein. For example, the distributed computing environment 700 can be utilized to execute aspects of the software components described herein.

According to various implementations, the distributed computing environment 700 includes a computing environment 702 operating on, in communication with, or as part of the network 704. The network 704 may be or may include the network 656, described above with reference to FIG. 8. The network 704 also can include various access networks. One or more client devices 706A-706N (hereinafter referred to collectively and/or generically as “clients 706” and also referred to herein as computing devices 106) can communicate with the computing environment 702 via the network 704 and/or other connections (not illustrated in FIG. 9). In one illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of clients 706 can communicate with the computing environment 702. It should be understood that the illustrated clients 706 and computing architectures illustrated and described herein are illustrative, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. In the illustrated configuration, the application servers 708 host one or more virtual machines 714 for hosting applications or other functionality. According to various implementations, the virtual machines 714 host one or more applications and/or software modules for enabling efficient testing disclosed herein. It should be understood that this configuration is illustrative, and should not be construed as being limiting in any way. The application servers 708 also host or provide access to one or more portals, link pages, Web sites, and/or other information (“Web portals”) 716.

According to various implementations, the application servers 708 also include one or more mailbox services 718 and one or more messaging services 720. The mailbox services 718 can include electronic mail (“email”) services. The mailbox services 718 also can include various personal information management (“PIM”) and presence services including, but not limited to, calendar services, contact management services, collaboration services, and/or other services. The messaging services 720 can include, but are not limited to, instant messaging services, chat services, forum services, and/or other communication services.

The application servers 708 also may include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 722 are provided by or include the FACEBOOK social networking service, LINKEDIN professional networking service, GOOGLE HANGOUTS networking service, SLACK networking service, YAMMER office colleague networking service, and the like. In other configurations, the social networking services 722 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 722 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 722 are not mentioned herein for the sake of brevity. As such, the above configurations are illustrative, and should not be construed as being limited in any way. According to various implementations, the social networking services 722 may host one or more applications and/or software modules for providing the functionality described herein. For instance, any one of the application servers 708 may communicate or facilitate the functionality and features described herein. For instance, a social networking application, mail client, messaging client or a browser running on a phone or any other client 706 may communicate with a networking service 722 and facilitate the functionality, even in part, described above with respect to FIG. 9. Any device or service depicted herein can be used as a resource for supplemental data, including email servers, storage servers, etc.

As shown in FIG. 9, the application servers 708 also can host other services, applications, portals, and/or other resources (“other resources”) such as a service managing a communication session 724. The communication session 724 can include, but is not limited to, document sharing, text sharing, video sharing, etc. It thus can be appreciated that the computing environment 702 can provide integration of the concepts and technologies disclosed herein with various mailbox, messaging, social networking, and/or other services or resources.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual datastores 726A-726N (hereinafter referred to collectively and/or generically as “datastores 726”). The datastores 726 are configured to host data used or created by the application servers 708 and/or other data. Although not illustrated in FIG. 9, the datastores 726 also can host or store web page documents, word documents, presentation documents, data structures, algorithms for execution by a recommendation engine, and/or other data utilized by any application program or another module. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including, but not limited to, the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects. In one specific example, as summarized above, techniques described herein may be implemented, at least in part, by web browser application, which works in conjunction with the application servers 708 of FIG. 9.

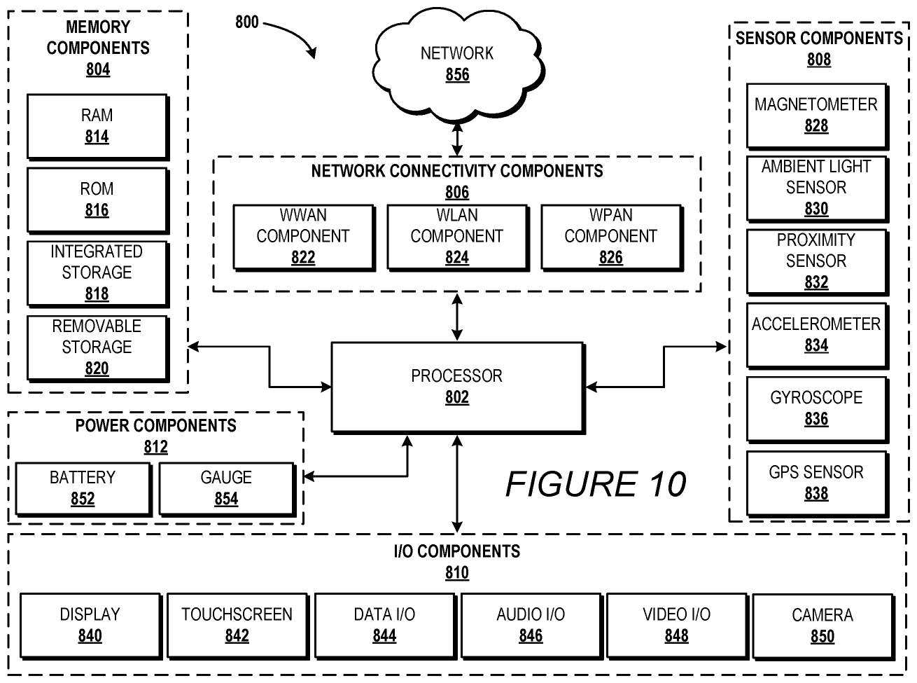

Turning now to FIG. 10, an illustrative computing device architecture 800 for a computing device that is capable of executing various software components described herein for enabling the techniques disclosed herein. The computing device architecture 800, also referred to as a computer 101 or computing device 101, is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 800 is applicable to any of the computing devices shown in the figures. Moreover, aspects of the computing device architecture 800 may be applicable to traditional desktop computers, portable computers (e.g., phones, laptops, notebooks, ultra-portables, and netbooks), server computers, and other computer systems, such as described herein with reference to FIG. 1. For example, the single touch and multi-touch aspects disclosed herein below may be applied to desktop computers that utilize a touchscreen or some other touch-enabled device, such as a touch-enabled track pad or touch-enabled mouse.

The computing device architecture 800 illustrated in FIG. 10 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individuals components illustrated in FIG. 10, the components can interact to carry out device functions. In some configurations, the components are arranged so as to communicate via one or more busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 may be utilized to execute aspects of the software components presented herein.

In some configurations, the processor 802 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 802 is configured to communicate with a discrete GPU (not shown). In any case, the CPU and GPU may be configured in accordance with a co-Newport processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC may include the processor 802, a GPU, one or more of the network connectivity components 806, and one or more of the sensor components 808. In some configurations, the processor 802 is fabricated, in part, utilizing a package-on-package (“PoP”) integrated circuit packaging technique. The processor 802 may be a single core or multi-core processor.

The processor 802 may be created in accordance with an ARM architecture, available for license from ARM HOLDINGS of Cambridge, United Kingdom. Alternatively, the processor 802 may be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a random access memory (“RAM”) 814, a read-only memory (“ROM”) 816, an integrated storage memory (“integrated storage”) 818, and a removable storage memory (“removable storage”) 820. In some configurations, the RAM 814 or a portion thereof, the ROM 816 or a portion thereof, and/or some combination of the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 and/or the removable storage 820.

The integrated storage 818 can include a solid-state memory, a hard disk, or a combination of solid-state memory and a hard disk. The integrated storage 818 may be soldered or otherwise connected to a logic board upon which the processor 802 and other components described herein also may be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available as a total combined storage capacity. In some configurations, the total combined capacity of the integrated storage 818 and the removable storage 820 is shown to a user instead of separate storage capacities for the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from the network 856 or another network, which may be a WWAN, a WLAN, or a WPAN. Although only the network 856 is illustrated, the network connectivity components 806 may facilitate simultaneous communication with multiple networks, including the network 604 of FIG. 14. For example, the network connectivity components 806 may facilitate simultaneous communications with multiple networks via one or more of a WWAN, a WLAN, or a WPAN.

The network 856 may be or may include a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 856 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 856 may be configured to provide voice and/or data communications with any combination of the above technologies. The network 856 may be configured to or adapted to provide voice and/or data communications in accordance with future generation technologies.

In some configurations, the WWAN component 822 is configured to provide dual- multi-mode connectivity to the network 856. For example, the WWAN component 822 may be configured to provide connectivity to the network 856, wherein the network 856 provides service via GSM and UMTS technologies, or via some other combination of technologies. Alternatively, multiple WWAN components 822 may be utilized to perform such functionality, and/or provide additional functionality to support other non-compatible technologies (i.e., incapable of being supported by a single WWAN component). The WWAN component 822 may facilitate similar connectivity to multiple networks (e.g., a UMTS network and an LTE network).

The network 856 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 856 via the WI-FI access points. Such connections may be secured via various encryption technologies including, but not limited, WI-FI Protected Access (“WPA”), WPA2, Wired Equivalent Privacy (“WEP”), and the like.

The network 856 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 828, an ambient light sensor 830, a proximity sensor 832, an accelerometer 834, a gyroscope 836, and a Global Positioning System sensor (“GPS sensor”) 838. It is contemplated that other sensors, such as, but not limited to, temperature sensors or shock detection sensors, also may be incorporated in the computing device architecture 800.

The magnetometer 828 is configured to measure the strength and direction of a magnetic field. In some configurations the magnetometer 828 provides measurements to a compass application program stored within one of the memory components 804 in order to provide a user with accurate directions in a frame of reference including the cardinal directions, north, south, east, and west. Similar measurements may be provided to a navigation application program that includes a compass component. Other uses of measurements obtained by the magnetometer 828 are contemplated.

The ambient light sensor 830 is configured to measure ambient light. In some configurations, the ambient light sensor 830 provides measurements to an application program stored within one the memory components 804 in order to automatically adjust the brightness of a display (described below) to compensate for low-light and high-light environments. Other uses of measurements obtained by the ambient light sensor 830 are contemplated.

The proximity sensor 832 is configured to detect the presence of an object or thing in proximity to the computing device without direct contact. In some configurations, the proximity sensor 832 detects the presence of a user's body (e.g., the user's face) and provides this information to an application program stored within one of the memory components 804 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 832 are contemplated.

The accelerometer 834 is configured to measure proper acceleration. In some configurations, output from the accelerometer 834 is used by an application program as an input mechanism to control some functionality of the application program. For example, the application program may be a video game in which a character, a portion thereof, or an object is moved or otherwise manipulated in response to input received via the accelerometer 834. In some configurations, output from the accelerometer 834 is provided to an application program for use in switching between landscape and portrait modes, calculating coordinate acceleration, or detecting a fall. Other uses of the accelerometer 834 are contemplated.

The gyroscope 836 is configured to measure and maintain orientation. In some configurations, output from the gyroscope 836 is used by an application program as an input mechanism to control some functionality of the application program. For example, the gyroscope 836 can be used for accurate recognition of movement within a 3D environment of a video game application or some other application. In some configurations, an application program utilizes output from the gyroscope 836 and the accelerometer 834 to enhance control of some functionality of the application program. Other uses of the gyroscope 836 are contemplated.

The GPS sensor 838 is configured to receive signals from GPS satellites for use in calculating a location. The location calculated by the GPS sensor 838 may be used by any application program that requires or benefits from location information. For example, the location calculated by the GPS sensor 838 may be used with a navigation application program to provide directions from the location to a destination or directions from the destination to the location. Moreover, the GPS sensor 838 may be used to provide location information to an external location-based service, such as E911 service. The GPS sensor 838 may obtain location information generated via WI-FI, WIMAX, and/or cellular triangulation techniques utilizing one or more of the network connectivity components 806 to aid the GPS sensor 838 in obtaining a location fix. The GPS sensor 838 may also be used in Assisted GPS (“A-GPS”) systems. The GPS sensor 838 can also operate in conjunction with other components, such as the processor 802, to generate positioning data for the computing device 800.

The I/O components 810 include a display 840, a touchscreen 842, a data I/O interface component (“data I/O”) 844, an audio I/O interface component (“audio I/O”) 846, a video I/O interface component (“video I/O”) 848, and a camera 850. In some configurations, the display 840 and the touchscreen 842 are combined. In some configurations two or more of the data I/O component 844, the audio I/O component 846, and the video I/O component 848 are combined. The I/O components 810 may include discrete processors configured to support the various interface described below, or may include processing functionality built-in to the processor 802.

The display 840 is an output device configured to present information in a visual form. In particular, the display 840 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 840 is a liquid crystal display (“LCD”) utilizing any active or passive matrix technology and any backlighting technology (if used). In some configurations, the display 840 is an organic light emitting diode (“OLED”) display. Other display types are contemplated.

The touchscreen 842, also referred to herein as a “touch-enabled screen,” is an input device configured to detect the presence and location of a touch. The touchscreen 842 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 842 is incorporated on top of the display 840 as a transparent layer to enable a user to use one or more touches to interact with objects or other information presented on the display 840. In other configurations, the touchscreen 842 is a touch pad incorporated on a surface of the computing device that does not include the display 840. For example, the computing device may have a touchscreen incorporated on top of the display 840 and a touch pad on a surface opposite the display 840.

In some configurations, the touchscreen 842 is a single-touch touchscreen. In other configurations, the touchscreen 842 is a multi-touch touchscreen. In some configurations, the touchscreen 842 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 842. As such, a developer may create gestures that are specific to a particular application program.

In some configurations, the touchscreen 842 supports a tap gesture in which a user taps the touchscreen 842 once on an item presented on the display 840. The tap gesture may be used for various reasons including, but not limited to, opening or launching whatever the user taps. In some configurations, the touchscreen 842 supports a double tap gesture in which a user taps the touchscreen 842 twice on an item presented on the display 840. The double tap gesture may be used for various reasons including, but not limited to, zooming in or zooming out in stages. In some configurations, the touchscreen 842 supports a tap and hold gesture in which a user taps the touchscreen 842 and maintains contact for at least a pre-defined time. The tap and hold gesture may be used for various reasons including, but not limited to, opening a context-specific menu.

In some configurations, the touchscreen 842 supports a pan gesture in which a user places a finger on the touchscreen 842 and maintains contact with the touchscreen 842 while moving the finger on the touchscreen 842. The pan gesture may be used for various reasons including, but not limited to, moving through screens, images, or menus at a controlled rate. Multiple finger pan gestures are also contemplated. In some configurations, the touchscreen 842 supports a flick gesture in which a user swipes a finger in the direction the user wants the screen to move. The flick gesture may be used for various reasons including, but not limited to, scrolling horizontally or vertically through menus or pages. In some configurations, the touchscreen 842 supports a pinch and stretch gesture in which a user makes a pinching motion with two fingers (e.g., thumb and forefinger) on the touchscreen 842 or moves the two fingers apart. The pinch and stretch gesture may be used for various reasons including, but not limited to, zooming gradually in or out of a web site, map, or picture.

Although the above gestures have been described with reference to the use of one or more fingers for performing the gestures, other appendages such as toes or objects such as styluses may be used to interact with the touchscreen 842. As such, the above gestures should be understood as being illustrative and should not be construed as being limiting in any way.

The data I/O interface component 844 is configured to facilitate input of data to the computing device and output of data from the computing device. In some configurations, the data I/O interface component 844 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 846 is configured to provide audio input and/or output capabilities to the computing device. In some configurations, the audio I/O interface component 846 includes a microphone configured to collect audio signals. In some configurations, the audio I/O interface component 846 includes a headphone jack configured to provide connectivity for headphones or other external speakers. In some configurations, the audio I/O interface component 846 includes a speaker for the output of audio signals. In some configurations, the audio I/O interface component 846 includes an optical audio cable out.

The video I/O interface component 848 is configured to provide video input and/or output capabilities to the computing device. In some configurations, the video I/O interface component 848 includes a video connector configured to receive video as input from another device (e.g., a video media player such as a DVD or BLURAY player) or send video as output to another device (e.g., a monitor, a television, or some other external display). In some configurations, the video I/O interface component 848 includes a High-Definition Multimedia Interface (“HDMI”), mini-HDMI, micro-HDMI, DisplayPort, or proprietary connector to input/output video content. In some configurations, the video I/O interface component 848 or portions thereof is combined with the audio I/O interface component 846 or portions thereof.

The camera 850 can be configured to capture still images and/or video. The camera 850 may utilize a charge coupled device (“CCD”) or a complementary metal oxide semiconductor (“CMOS”) image sensor to capture images. In some configurations, the camera 850 includes a flash to aid in taking pictures in low-light environments. Settings for the camera 850 may be implemented as hardware or software buttons.

Although not illustrated, one or more hardware buttons may also be included in the computing device architecture 800. The hardware buttons may be used for controlling some operational aspect of the computing device. The hardware buttons may be dedicated buttons or multi-use buttons. The hardware buttons may be mechanical or sensor-based buttons.

The illustrated power components 812 include one or more batteries 852, which can be connected to a battery gauge 854. The batteries 852 may be rechargeable or disposable. Rechargeable battery types include, but are not limited to, lithium polymer, lithium ion, nickel cadmium, and nickel metal hydride. Each of the batteries 852 may be made of one or more cells.

The battery gauge 854 can be configured to measure battery parameters such as current, voltage, and temperature. In some configurations, the battery gauge 854 is configured to measure the effect of a battery's discharge rate, temperature, age and other factors to predict remaining life within a certain percentage of error. In some configurations, the battery gauge 854 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 812 may also include a power connector, which may be combined with one or more of the aforementioned I/O components 810. The power components 812 may interface with an external power system or charging equipment via an I/O component.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computer-implemented method for guiding an eye gaze direction of a user toward a camera generating video data for transmission to remote devices, the computer-implemented method for execution on the computing device comprising:
receiving configuration data indicating a position of the camera relative to a display screen in communication with the computing device;
analyzing the configuration data to determine a location for a graphical user interface displaying a rendering of content, wherein the location of the graphical user interface is based on the position of the camera relative to the display screen; and
causing a display of the graphical user interface on the display screen at the determined location causing the graphical user interface to be displayed in proximity to the camera for allowing the user to view the content while guiding the eye gaze direction of the user toward the camera.

2. The computer-implemented method of claim 1, further comprising:
receiving orientation data from a sensor mounted to the computing device, the orientation data indicating a rotation of the display screen from a first physical orientation to a second physical orientation;
in response to determining that the display screen has rotated from the first physical orientation to the second physical orientation, analyzing the configuration data to determine a second location for the graphical user interface based on the position of the camera relative to the display screen while the computing device is in the second physical orientation; and
moving the graphical user interface to the second location for allowing the user to maintain the view of the content while the second position of the graphical user interface continues to guide the eye gaze direction of the user toward the camera.

3. The computer-implemented method of claim 1, wherein the configuration data indicates that the display screen is closer to the camera than at least one other display screen in communication with the computing device, where the computer-implemented method further comprises: selecting the display screen for the display of the graphical user interface in response to determining that the display screen is closer to the camera than the at least one other display screen.

4. The computer-implemented method of claim 1, wherein the configuration data indicates that the display screen is closer to the camera than at least one other display screen in communication with the computing device, wherein the computer-implemented method further comprises:
initially displaying the graphical user interface on the at least one other display screen; and
in response to determining that the video data has begun transmission to the remote devices participating in a communication session, moving the graphical user interface from the at least one other display screen to the display screen at the determined location based on the configuration data.

5. The computer-implemented method of claim 1, wherein the configuration data indicates that the display screen is closer to the camera than at least one other display screen in communication with the computing device, wherein the computer-implemented method further comprises: in response to determining that the video data stops transmission to the remote devices participating in a communication session, moving the graphical user interface from the display screen to the at least one other display screen.

6. The computer-implemented method of claim 1, wherein the configuration data indicates a position of a second camera relative to a second display screen in communication with the computing device, wherein the computer-implemented method further comprises:
receiving sensor data from the camera or the second camera indicating that the user has moved to closer to the second camera than the camera or that the user has provided a user input indicating that the user has moved toward the second camera or the second display screen; and
in response to determining that the user has moved to closer to the second camera than the camera or that the user input indicates that the user has moved toward the second camera or the second display screen, moving the graphical user interface to the second display screen from the display screen, wherein the graphical user interface is positioned at a second location on the second display screen according to configuration data, wherein the second location allows the user to view the content on the second screen while guiding the eye gaze direction of the user toward the second camera.

7. The computer-implemented method of claim 1, further comprising: in response to determining that at least one of a light level, an audio quality level, or a score of an associated camera angle meet one or more criteria, generating a notification instructing the user to move to a position that enables the computing device to generate video data or corresponding audio data having at least one of the light level, the audio quality level, or the score of an associated camera angle within one or more thresholds.

8. The computer-implemented method of claim 1, further comprising:
in response to determining that at least one of a light level, an audio quality level, or a score of an associated camera angle meet one or more criteria or in response to a detection of an activity type, determine a recommended position for the user that enables the computing device to generate video data and corresponding audio data having at least one of the light level, the audio quality level, or the score of an associated camera angle within one or more thresholds;
determining a selected camera from a plurality of cameras and a selected display screen from a plurality of display screens based on the recommended position; and
activating the selected camera to transmit the video data to the remote devices participating in a communication session; and
moving the graphical user interface from the display screen to the selected display screen.

9. A computing device for guiding an eye gaze direction of a user toward a camera generating video data, the computing device comprising:
one or more processing units; and
a computer-readable storage medium having encoded thereon computer-executable instructions to cause the one or more processing units to perform a method comprising
receiving configuration data indicating a position of the camera relative to a display screen in communication with the computing device;
analyzing the configuration data to determine a location for a selected content rendering of a plurality of content renderings, wherein the location of the selected content rendering is based on the position of the camera relative to the display screen; and
causing a display of the selected content rendering on the display screen at the determined location causing the selected content rendering to be displayed in proximity to the camera for allowing the user to view the selected content rendering while guiding the eye gaze direction of the user toward the camera.

10. The computing device of claim 9, wherein the method further comprises: determining an arrangement for the plurality of content renderings, wherein the arrangement positions the selected content rendering closer to the camera than the remaining renderings of the plurality of content renderings.

11. The computing device of claim 9, wherein the method further comprises:
determining a priority for each of the plurality of content renderings; and
determining an arrangement for the plurality of content renderings, wherein the arrangement positions the plurality of content renderings according to the priority for each of the plurality of content renderings, where a highest priority content rendering is the selected content rendering and the remaining renderings are at a distance to the camera based on the priority for each of the remaining renderings.

12. The computing device of claim 9, wherein the method further comprises:
receiving orientation data from a sensor mounted to the computing device, the orientation data indicating a rotation of the display screen from a first physical orientation to a second physical orientation;
in response to determining that the display screen has rotated from the first physical orientation to the second physical orientation, analyzing the configuration data to determine a second location for the selected content rendering based on the position of the camera relative to the display screen while the computing device is in the second physical orientation; and
moving the selected content rendering to the second location for allowing the user to maintain the view of the content while the second position of the selected content rendering continues to guide the eye gaze direction of the user toward the camera.

13. The computing device of claim 9, wherein the computing device determines the selected content rendering based on an activity level associated with the selected content rendering, the activity level is based on at least one of a number of people depicted in the selected content rendering, a data type of the selected content rendering, or a volume level of an audio stream associated with the selected content rendering.

14. The computing device of claim 9, wherein the configuration data indicates that the display screen is closer to the camera than at least one other display screen in communication with the computing device, wherein the method further comprises:
initially displaying the selected content rendering on the at least one other display screen; and
in response to determining that the video data has begun transmission to the remote devices participating in a communication session, moving the selected content rendering from the at least one other display screen to the display screen at the determined location based on the configuration data.

15. A computing device, comprising:
means for receiving configuration data indicating a position of the camera relative to a display screen in communication with the computing device;
means for analyzing the configuration data to determine a location for a graphical user interface displaying a rendering of content, wherein the location of the graphical user interface is based on the position of the camera relative to the display screen; and
means for causing a display of the graphical user interface on the display screen at the determined location causing the graphical user interface to be displayed in proximity to the camera for allowing the user to view the content while guiding the eye gaze direction of the user toward the camera.

16. The computing device of claim 15, further comprising:
means for receiving orientation data from a sensor mounted to the computing device, the orientation data indicating a rotation of the display screen from a first physical orientation to a second physical orientation;
means for analyzing the configuration data to determine a second location for the graphical user interface based on the position of the camera relative to the display screen while the computing device is in the second physical orientation, in response to determining that the display screen has rotated from the first physical orientation to the second physical orientation; and
means for moving the graphical user interface to the second location for allowing the user to maintain the view of the content while the second position of the graphical user interface continues to guide the eye gaze direction of the user toward the camera.

17. The computing device of claim 15, wherein the configuration data indicates that the display screen is closer to the camera than at least one other display screen in communication with the computing device, where the computer-implemented method further comprises: selecting the display screen for the display of the graphical user interface in response to determining that the display screen is closer to the camera than the at least one other display screen.

18. The computing device of claim 15, wherein the configuration data indicates that the display screen is closer to the camera than at least one other display screen in communication with the computing device, wherein the computing device further comprises:
means for initially displaying the graphical user interface on the at least one other display screen; and
means for moving the graphical user interface from the at least one other display screen to the display screen at the determined location based on the configuration data, wherein the graphical user interface is moved in response to determining that the video data has begun transmission to the remote devices participating in a communication session.

19. The computing device of claim 15, wherein the configuration data indicates that the display screen is closer to the camera than at least one other display screen in communication with the computing device, wherein the computer-implemented method further comprises: in response to determining that the video data stops transmission to the remote devices participating in a communication session, moving the graphical user interface from the display screen to the at least one other display screen.

20. The computing device of claim 15, further comprising: means for generating a notification instructing the user to move to a position that enables the computing device to generate video data and corresponding audio data having at least one of a light level, a audio quality level, or a score of an associated camera angle within one or more thresholds, the notification generated in response to determining that at least one of the light level, the audio quality level, or the score of an associated camera angle meet one or more criteria.
